(19) United States
(12) Patent Application Publication
(10) Pub. No.: US 2026/0247262 A1
(43) Pub. Date: Aug. 20, 2026

(54) COMMUNICATION METHOD AND APPARATUS BASED ON NETWORK SLICING

(71) Applicant: BEIJING XIAOMI MOBILE SOFTWARE CO., LTD., Beijing (CN)

(72) Inventors: Haoran LIANG, Beijing (CN); Wei LU, Beijing (CN)

(21) Appl. No.: 19/472,546

(22) PCT Filed: Apr. 7, 2023
(86) PCT No.: PCT/CN2023/087137

§ 371 Date: Oct. 3, 2025

(51) Int. Cl. H04W 48/06; H04W 60/00

(52) U.S. Cl. CPC H04W 48/06; H04W 60/001; H04W 60/002

(57) ABSTRACT

A communication method based on network slicing, performed by a first network device, comprising: receiving a first request sent from a second network device, wherein the first request is used to request the first network device to process a network slice admission control (NSAC) request related to a number of terminals corresponding to first single network slice selection assistance information (S-NSSAI); and verifying at least one of: whether a total number of terminals registered to a network slice corresponding to the first S-NSSAI reaches a first quota; or whether a proportion of terminals registered to the network slice corresponding to the first S-NSSAI reaches a second quota.

### CROSS-REFERENCE TO RELATED APPLICATIONS

This application is a U.S. national phase of International Application No. PCT/CN 2023/087137, filed on Apr. 7, 2023, the entire content of which is incorporated herein by reference.

### TECHNICAL FIELD

The present disclosure relates to the field of communication technology, and in particular to a communication method and device based on network slicing.

### BACKGROUND

In the related art, an issue of how to support network slice admission control (NSAC) involving multiple service areas is studied. A general assumption is that one primary network slice admission control function (NSACF) and multiple NSACFs are required, and each NSACF is used for its corresponding service area. To limit the number of user equipment (UEs)/protocol data unit (PDU) sessions that a specific NSACF can control, the primary NSACF allocates a quota or a ratio (threshold) for the number of UEs/PDU sessions to each NSACF under its control.

### SUMMARY

Embodiments of a first aspect of the present disclosure provide a communication method based on network slicing, performed by a first network device, and including: receiving a first request sent from a second network device, wherein the first request is used to request the first network device to process a network slice admission control (NSAC) request related to a number of terminals corresponding to first single network slice selection assistance information (S-NSSAI); and verifying whether a total number of terminals registered to a network slice corresponding to the first S-NSSAI and/or a proportion of terminals registered to the network slice corresponding to the first S-NSSAI reaches a quota.

Embodiments of a second aspect of the present disclosure provide a communication method based on network slicing, performed by a third network device, and including: sending first information to a first network device; wherein the first information is used for the first network device to verify whether a total number and/or a proportion of terminals registered to a network slice corresponding to first single network slice selection assistance information (S-NSSAI) reaches a quota corresponding to the first S-NSSAI after receiving a first request sent from a second network device; the first request is used to request the first network device to process a network slice admission control (NSAC) request related to a number of terminals corresponding to the first S-NSSAI, and the third network device is controlled by the second network device.

Embodiments of a third aspect of the present disclosure provide a communication method based on network slicing, performed by a first network device, and including: receiving a second request sent from a second network device, wherein the second request is used to request the first network device to process a network slice admission control (NSAC) request related to a number of protocol data unit (PDU) sessions corresponding to first single network slice selection assistance information (S-NSSAI); and verifying whether a total number of PDU sessions belonging to a network slice corresponding to the first S-NSSAI reaches a quota.

Embodiments of a fourth aspect embodiment of the present disclosure provide a communication device, which includes a processor and a memory. The memory stores a computer program, and the processor executes the computer program stored in the memory so that the device executes the communication method based on network slicing described in embodiments of the first aspect, or executes the communication method based on network slicing described in the embodiments of the third aspect.

Embodiments of a fifth aspect embodiment of the present disclosure provide a communication device, which includes a processor and a memory. The memory stores a computer program, and the processor executes the computer program stored in the memory so that the device executes the communication method based on network slicing described in embodiments of the second aspect.

Embodiments of a sixth embodiment of the present disclosure provide a communication device, which includes a processor and a memory. The memory stores a computer program, and the processor executes the computer program stored in the memory so that the device executes the communication method based on network slicing described in embodiments of the fourth aspect.

Embodiments of a seventh aspect embodiment of the present disclosure provide a computer-readable storage medium for storing instructions. When the instructions are executed, the communication method based on network slicing described in embodiments of the first aspect is implemented, or the communication method based on network slicing described in embodiments of the third aspect is implemented.

Embodiments of an eighth aspect embodiment of the present disclosure provide a computer-readable storage medium for storing instructions. When the instructions are executed, the communication method based on network slicing described in embodiments of the second aspect is implemented.

Embodiments of a ninth aspect embodiment of the present disclosure provide a computer-readable storage medium for storing instructions. When the instructions are executed, the communication method based on network slicing described in embodiments of the fourth aspect is implemented.

### BRIEF DESCRIPTION OF THE DRAWINGS

To clearly illustrate the technical solutions in embodiments of the present disclosure or the background technology, the drawings required for use in embodiments of the present disclosure or the background technology are described below.

FIG. 1 is a schematic diagram of an architecture of a communication system provided in an embodiment of the present disclosure.

FIG. 2 is a flow chart of a communication method based on network slicing provided in an embodiment of the present disclosure.

FIG. 3 is a flow chart of a communication method based on network slicing provided in an embodiment of the present disclosure.

FIG. 4 is a flow chart of a communication method based on network slicing provided in an embodiment of the present disclosure.

FIG. 5 is a flow chart of a communication method based on network slicing provided in an embodiment of the present disclosure.

FIG. 6 is a flow chart of a communication method based on network slicing provided in an embodiment of the present disclosure.

FIG. 7 is a flow chart of a communication method based on network slicing provided in an embodiment of the present disclosure.

FIG. 8 is a flow chart of a communication method based on network slicing provided in an embodiment of the present disclosure.

FIG. 9 is a flow chart of a communication method based on network slicing provided in an embodiment of the present disclosure.

FIG. 10 is a flow chart of a communication method based on network slicing provided in an embodiment of the present disclosure.

FIG. 11 is a flow chart of a communication method based on network slicing provided in an embodiment of the present disclosure.

FIG. 12 is a block diagram of a communication device based on network slicing provided in an embodiment of the present disclosure.

FIG. 13 is a block diagram of a communication device based on network slicing provided in an embodiment of the present disclosure.

FIG. 14 is a block diagram of a communication device based on network slicing provided in an embodiment of the present disclosure.

FIG. 15 is a block diagram of a communication device based on network slicing provided in an embodiment of the present disclosure.

FIG. 16 is a schematic diagram of a communication system provided in an embodiment of the present disclosure.

FIG. 17 is a block diagram of a communication device based on network slicing provided in an embodiment of the present disclosure.

FIG. 18 is a schematic diagram of a chip provided in an embodiment of the present disclosure.

### DETAILED DESCRIPTION

Embodiments are described in detail herein, examples of which are shown in the accompanying drawings. When the following description refers to the drawings, unless otherwise indicated, the same numbers in different drawings represent the same or similar elements. Implementations described in the following embodiments do not represent all implementations consistent with embodiments of the present disclosure. Instead, they are merely examples of devices and methods consistent with some aspects of embodiments of the present disclosure as detailed in the appended claims.

The terms used in embodiments of the present disclosure are only for the purpose of describing specific embodiments and are not intended to limit the embodiments of the present disclosure. The singular forms of “a” and “the” used in embodiments of the present disclosure and the appended claims are also intended to include plural forms, unless the context clearly indicates other meanings. It should also be understood that the term “and/or” used herein refers to and includes any or all possible combinations of one or more associated listed items.

It should be understood that, although the terms first, second, third, etc. may be used to describe various information in the embodiments of the present disclosure, these information should not be limited to these terms. These terms are only used to distinguish the same type of information from each other. For example, without departing from the scope of the embodiments of the present disclosure, the first information may also be referred to as the second information, and similarly, the second information may also be referred to as the first information. Depending on the context, the words “if” and “in a case where” as used herein may be interpreted as “at the time of” or “when . . . ” or “in response to determining”.

Embodiments of the present disclosure are described in detail below, and examples of the embodiments are shown in the accompanying drawings, in which the same or similar reference numerals throughout represent the same or similar elements. The embodiments described below with reference to the accompanying drawings are illustrative and are intended to be used to explain the present disclosure, and should not be construed as limiting the present disclosure.

In order to better understand the communication method based on network slicing disclosed in embodiments of the present disclosure, a communication system to which the embodiments of the present disclosure are applicable is described below.

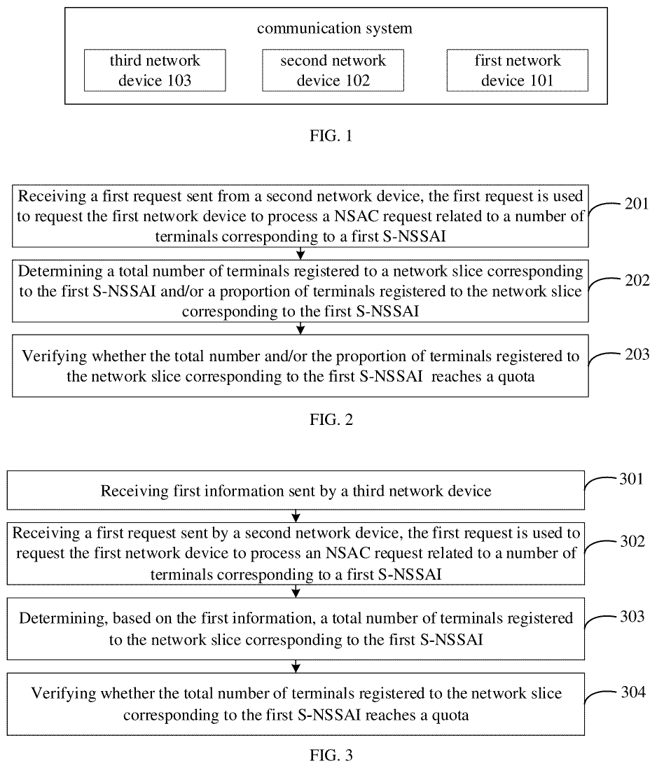

With reference to FIG. 1, FIG. 1 is a schematic diagram of an architecture of a communication system provided in an embodiment of the present disclosure. The communication system may include but is not limited to a first network device, a second network device and a third network device (or a fourth network device). The number and form of devices shown in FIG. 1 are only used for example and do not constitute a limitation on the embodiments of the present disclosure. In actual applications, two or more second network devices and two or more third network devices may be included. The communication system shown in FIG. 1 takes one first network device 101, one second network device 102 and one third network device 103 as an example.

It should be noted that the technical solutions of embodiments of the present disclosure can be applied to various communication systems, such as a Long Term Evolution (LTE) system, a fifth generation mobile communication system, a 5G new radio system, or other future new mobile communication systems.

In embodiments of the present disclosure, the first network device 101, the second network device 102, the third network device 103 and other network devices are entities on the network side that can independently complete certain transmission functions. The first network device 101, the second network device 102 and the third network device 103 can be network element functions deployed in a core network. The first network device 101 can be a primary network slice admission control function (NSACF), the second network device can be an NSACF, and the third network device can be an access and mobility management function (AMF) or a session management function (SMF). Embodiments of the present disclosure do not limit the specific technology and specific device form adopted by the network device.

The terminal in embodiments of the present disclosure is an entity for receiving or transmitting signals on the user side, such as a mobile phone. The terminal may also be referred to as a terminal device (terminal), a user equipment (UE), a mobile station (MS), a mobile terminal (MT), etc. The terminal may be a car with a communication function, a smart car, a mobile phone, a wearable device, a tablet computer (Pad), a computer with a wireless transceiver function, a virtual reality (VR) terminal, an augmented reality (AR) terminal, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home, etc. Embodiments of the present disclosure do not limit the specific technology and specific device form adopted by the terminal.

In the related art, a problem of how to support network slice admission control (NSAC) involving multiple service areas is studied. A general assumption is that a primary NSACF and multiple NSACFs are required, each NSACF is used for its corresponding service area. To limit a number of user equipment (UEs)/protocol data unit (PDU) sessions that a specific NSACF can control, the primary NSACF allocates a quota of the number of UEs/PDU sessions to each NSACF under its control.

When a number of accessed UEs does not reach the quota, the NSACF can determine whether the UE can access a network slice. When the number of accessed UEs reaches the quota, the NSACF may interact with the primary NSACF to determine whether a new UE can access the network slice.

Similarly, when a number of established PDU sessions does not reach the quota, the NSACF can determine whether the UE can establish a PDU session towards a network slice. When the number of established PDU sessions reaches the quota, the NSACF may interact with the primary NSACF to determine whether the UE can establish a new PDU session in the network slice.

However, some malicious or compromised NSACFs in a network service area with low security protection may send a fake message to the primary NSACF to indicate that the number of UEs/PDU sessions reaches a maximum number, which may cause the primary NSACF to reallocate the quota of the maximum number of UEs/PDU sessions to the NSACFs in the service area, ultimately affecting services of other benign service areas.

It can be understood that in embodiments of the present disclosure, the information interaction between the terminal and each core network device is completed through transparent transmission of an access network device.

It can be understood that the communication system described in embodiments of the present disclosure is for clearly illustrating the technical solution of embodiments of the present disclosure, and does not constitute a limitation on the technical solution provided in embodiments of the present disclosure. Those skilled in the art can know that with the evolution of the system architecture and the emergence of new service scenarios, the technical solution provided in embodiments of the present disclosure is also applicable to similar technical problems.

The communication method and device based on network slicing provided in the present disclosure are described in detail below in conjunction with the accompanying drawings.

With reference to FIG. 2, FIG. 2 is a flow chart of a communication method based on network slicing provided in an embodiment of the present disclosure. It should be noted that the communication method based on network slicing in embodiments of the present disclosure is performed by a first network device. The method can be performed independently or in combination with any other embodiments of the present disclosure. As shown in FIG. 2, the method can include the following steps.

Step 201, a first request sent by a second network device is received, the first request is used to request the first network device to process a NSAC request related to a number of terminals corresponding to first single network slice selection assistance information (S-NSSAI).

In embodiments of the present disclosure, the first network device can receive the first request sent by the second network device, and the first request is used to request the first network device to process the NSAC request related to the number of terminals corresponding to the first S-NSSAI.

The NSAC request related to the number of terminals refers to availability check and update of the number of UEs per network slice (number of UEs per network slice availability check and update).

In embodiments of the present disclosure, the first network device is a primary NSACF, and the second network device is an NSACF under the control of the primary NSACF.

Optionally, a request for requesting to process the NSAC request related to the number of terminals corresponding to the first S-NSSAI includes requesting to increase the quota of terminals corresponding to the first S-NSSAI, in which the quota of terminals may be a number of terminals allowed to be registered to a network slice corresponding to the first S-NSSAI (a maximum number of registered UEs), or a proportion of terminals allowed to be registered to the network slice corresponding to the first S-NSSAI (a UE admission threshold).

It can be understood that in embodiments of the present disclosure, the network slice corresponding to the first S-NSSAI is a network slice uniquely identified by the first S-NSSAI.

It should be noted that in embodiments of the present disclosure, the proportion of terminals allowed to be registered to the network slice corresponding to the first S-NSSAI refers to a ratio of a number of terminals allowed to be registered to the network slice corresponding to the first S-NSSAI to a preconfigured total number. The preconfigured total number can be the maximum number of registered UEs or another value, which is not limited in embodiments of the present disclosure. For example, the proportion can be 80%, etc.

Step 202, a total number of terminals registered to a network slice corresponding to the first S-NSSAI and/or a proportion of terminals registered to the network slice corresponding to the first S-NSSAI is determined.

In embodiments of the present disclosure, the first network device can determine the total number of terminals registered to the network slice corresponding to the first S-NSSAI, and/or the proportion of terminals registered to the network slice corresponding to the first S-NSSAI.

It can be understood that the proportion is a ratio of a total number of terminals registered to the network slice corresponding to the first S-NSSAI to the preconfigured total number aforementioned.

In some embodiments, the first network device can determine the total number of terminals registered to the network slice corresponding to the first S-NSSAI and/or the proportion of terminals registered to the network slice corresponding to the first S-NSSAI based on first information sent by the third network device to the first network device.

The third network device is controlled by the second network device.

In embodiments of the present disclosure, the third network device is an access and mobility management function (AMF).

It should be noted that the third network device is controlled by the second network device, which means that the second network device may provide the third network device with the availability check and update service of the number of UEs per network slice (number of UEs per network slice availability check and update service).

Optionally, the first information includes at least one of: an identifier of the third network device; an identifier of the second network device; an allowed NSSAI of at least one terminal stored in the third network device; an identifier of the at least one terminal (UE ID); or an access type corresponding to each network slice in the allowed NSSAI, in which the access type comprises 3GPP (Third Generation Partnership Project) access and non-3GPP access.

Optionally, the identifier of the second network device may be a network function ID (NF ID), and the identifier of the third network device may be an NF ID.

The total number of terminals registered to the network slice corresponding to the first S-NSSAI and/or the proportion of terminals registered to the network slice corresponding to the first S-NSSAI is determined by the first network device according to at least one of the following in the first information: an identifier of the second network device; an allowed NSSAI of at least one terminal stored in the third network device; an identifier of the at least one terminal; or an access type corresponding to each network slice in the allowed NSSAI.

For example, after receiving the first request, the first network device can determine the identifier of the second network device that sends the first request, the first S-NSSAI for which a number of registered terminals needs to be counted, and an access type according to the first request, match to the first information stored locally according to the identifier of the second network device, and count the number of terminals registered to the network slice corresponding to the first S-NSSAI through the access type according to the identifier of the second network device, the allowed NSSAI, the identifier of the terminal, and the access type locally stored. Furthermore, the proportion of terminals registered to the network slice corresponding to the first S-NSSAI can be determined based on the counted number of terminals registered to the network slice corresponding to the first S-NSSAI.

It is understandable that in some embodiments, the system may stipulate that the network slice only supports one access type (for example, only supports the 3GPP access). Or the system may stipulate that the NSAC procedure does not need to consider the access type. In this case, the first information may not include the access type corresponding to each network slice, and the first network device does not need to perform statistics based on the access type when determining the number of terminals registered to the network slice.

Optionally, the first information also includes first instruction information; the first instruction information is used to instruct the first network device to increase or decrease a number of terminals registered to the network slice.

In the case where the third network device stores an allowed NSSAI of the terminal, the first instruction information is used to instruct the first network device to increase the number of terminals (i.e., the first instruction information is an increase indicator).

In the case where the third network device deletes an allowed NSSAI of the terminal, the first instruction information is used to instruct the first network device to decrease the number of terminals (i.e., the first instruction information is a decrease indicator).

Step 203, it is verifies whether the total number and/or the proportion of terminals registered to the network slice corresponding to the first S-NSSAI reaches a quota.

In embodiments of the present disclosure, after determining the total number of terminals registered to the network slice corresponding to the first S-NSSAI and/or the proportion of terminals registered to the network slice corresponding to the first S-NSSAI, the first network device can verify whether the total number and/or the proportion of the terminals reaches the quota.

In some embodiments, if the quota is the number of terminals (a maximum number of registered UEs) allowed to be registered to the network slice corresponding to the first S-NSSAI, in response to the total number of terminals registered to the network slice corresponding to the first S-NSSAI reaching the quota, the first network device can send a first response to the second network device. The first response is used to indicate that the first network device allows to update the quota of terminals corresponding to the first S-NSSAI.

If the quota is the maximum number of registered UEs allowed to be registered to the network slice corresponding to the first S-NSSAI, in response to the total number of terminals registered to the network slice corresponding to the first S-NSSAI not reaching the quota, the first network device rejects the first request.

In some embodiments, if the quota is a proportion of terminals allowed to be registered to the network slice corresponding to the first S-NSSAI (a UE admission threshold), in response to the proportion of terminals registered to the network slice corresponding to the first S-NSSAI reaching the quota, the first network device can send a first response to the second network device. The first response is used to indicate that the first network device allows to update the quota of terminals corresponding to the first S-NSSAI.

If the quota is the proportion of terminals allowed to be registered to the network slice corresponding to the first S-NSSAI (the UE admission threshold), in response to the proportion of terminals registered to the network slice corresponding to the first S-NSSAI not reaching the quota, the first network device rejects the first request.

In some embodiments, if the quota is the number of terminals (a maximum number of registered UEs) allowed to be registered to the network slice corresponding to the first S-NSSAI, in response to the total number of terminals registered to the network slice corresponding to the first S-NSSAI reaching the quota, the first network device can perform NSAC.

If the quota is the maximum number of registered UEs allowed to be registered to the network slice corresponding to the first S-NSSAI, in response to the total number of terminals registered to the network slice corresponding to the first S-NSSAI not reaching the quota, the first network device rejects the first request.

In some embodiments, if the quota is a proportion of terminals allowed to be registered to the network slice corresponding to the first S-NSSAI (a UE admission threshold), in response to the proportion of terminals registered to the network slice corresponding to the first S-NSSAI reaching the quota, the first network device can perform NSAC.

If the quota is the proportion of terminals allowed to be registered to the network slice corresponding to the first S-NSSAI (UE admission threshold), in response to the proportion of terminals registered to the network slice corresponding to the first S-NSSAI not reaching the quota, the first network device rejects the first request.

It should be noted that the first network device performing the NSAC means that the first network device determines whether to allow the terminal to register to a network slice. That is, the first network device may not update the quota, and the first network device independently determines whether the terminal can register to the network slice when the quota is full.

In addition, it should be noted that, in embodiments of the present disclosure, the total number of terminals registered to the network slice corresponding to the first S-NSSAI reaching the quota means that the total number is consistent with the quota, or a difference between the total number and the quota value is within an allowed difference range. Similarly, the proportion of terminals registered to the network slice corresponding to the first S-NSSAI reaching the quota means that the proportion is consistent with the quota, or a difference between the proportion and the quota value is within an allowed difference range.

In summary, by receiving the first request sent by the second network device, the first request is used to request the first network device to process the NSAC request related to the number of terminals corresponding to the first S-NSSAI, determining the total number of terminals registered to the network slice corresponding to the first S-NSSAI and/or the proportion of terminals registered to the network slice corresponding to the first S-NSSAI, and verifying whether the total number and/or the proportion of terminals registered to the network slice corresponding to the first S-NSSAI reaches the quota, the core network can determine and verify the number of terminals belonging to a specific network slice, thereby preventing malicious fake requests, effectively maintaining the security of the communication system, and ensuring the communication quality of the system.

With reference to FIG. 3, FIG. 3 is a flow chart of a communication method based on network slicing provided in an embodiment of the present disclosure. It should be noted that the communication method based on network slicing in embodiments of the present disclosure is performed by a first network device. The method can be performed independently or in combination with any other embodiments of the present disclosure. As shown in FIG. 3, the method may include the following steps.

Step 301, first information sent by a third network device is received.

In embodiments of the present disclosure, the first network device can receiving the first information sent by the third network device.

Optionally, the first network device can receive the first information sent when the third network device stores or deletes an allowed NSSAI of a terminal.

It should be noted that the third network device may send the first information due to other reasons.

Optionally, the first information includes at least one of the following information: an identifier of the third network device; an identifier of the second network device; an allowed NSSAI of at least one terminal stored in the third network device; an identifier of the at least one terminal (UE ID); or an access type corresponding to each network slice in the allowed NSSAI, in which the access type comprises 3GPP access and non-3GPP access.

The identifier of the second network device included in the first information is an identifier of the second network device that controls the third network device.

Optionally, the identifier of the second network device may be an NF ID, and the identifier of the third network device may be an NF ID.

It should be noted that the third network device is controlled by the second network device, which means that the second network device may provide the third network device with a number of UEs per network slice availability check and update service.

In embodiments of the present disclosure, the first network device is a primary NSACF, the second network device is an NSACF controlled by the primary NSACF, and the third network device is an AMF controlled by the NSACF.

Optionally, the first information also includes first instruction information; the first instruction information is used to instruct the first network device to increase or decrease the number of terminals registered to the network slice.

In a case where the third network device stores an allowed NSSAI of a terminal, the first instruction information is used to instruct the first network device to increase the number of terminals (i.e., the first instruction information is an increase indicator);

In a case where the third network device deletes n allowed NSSAI of a terminal, the first instruction information is used to instruct the first network device to decrease the number of terminals (i.e., the first instruction information is a decrease indicator).

Step 302, a first request sent by a second network device is received, the first request is used to request the first network device to process an NSAC request related to a number of terminals corresponding to a first S-NSSAI.

In embodiments of the present disclosure, the first network device can receive the first request sent by the second network device, in which the first request is used to request the first network device to process the NSAC request related to the number of terminals corresponding to the first S-NSSAI.

The NSAC request related to the number of terminals refers to availability check and update of the number of UEs per network slice (number of UEs per network slice availability check and update).

Optionally, in embodiments of the present disclosure, a quota of terminals corresponding to the first S-NSSAI is a number of terminals (a maximum number of registered UEs) allowed to be registered to the network slice corresponding to the first S-NSSAI.

In some embodiments, the quota of terminals corresponding to the first S-NSSAI may be the number of terminals (maximum number of registered UEs) allowed to be registered to the network slice corresponding to the first S-NSSAI, or a proportion of terminals allowed to be registered to the network slice corresponding to the first S-NSSAI (UE admission threshold).

It can be understood that in embodiments of the present disclosure, the network slice corresponding to the first S-NSSAI is a network slice uniquely identified by the first S-NSSAI.

Step 303, a total number of terminals registered to the network slice corresponding to the first S-NSSAI is determined based on the first information.

In embodiments of the present disclosure, after receiving the first request sent by the second network device, the first network device can determine the total number of terminals registered to the network slice corresponding to the first S-NSSAI based on the first information previously received.

In some implementations, the total number of terminals registered to the network slice corresponding to the first S-NSSAI is determined by the first network device according to at least one of the following in the first information: an identifier of the second network device; an allowed NSSAI of at least one terminal stored in the third network device; an identifier of the at least one terminal; or an access type corresponding to each network slice in the allowed NSSAI.

For example, after receiving the first request, the first network device can determine the identifier of the second network device that sends the first request, the first S-NSSAI for which a number of registered terminals needs to be counted, and an access type according to the first request, match to the first information stored locally according to the identifier of the second network device, and count the number of terminals registered to the network slice corresponding to the first S-NSSAI through the access type according to the identifier of the second network device, the allowed NSSAI, the identifier of the terminal, and the access type locally stored.

It is understandable that in some embodiments, the system may stipulate that the network slice only supports one access type (for example, only supports the 3GPP access). Or the system may stipulate that the NSAC procedure does not need to consider the access type. In this case, the first information may not include the access type corresponding to each network slice, and the first network device does not need to perform statistics based on the access type when determining the number of terminals registered to the network slice.

Step 304, it is verified whether the total number of terminals registered to the network slice corresponding to the first S-NSSAI reaches a quota.

In embodiments of the present disclosure, after determining the total number of terminals registered to the network slice corresponding to the first S-NSSAI, the first network device can verify whether the total number of terminals reaches the quota.

In some embodiments, in response to the total number of terminals registered to the network slice corresponding to the first S-NSSAI reaching the quota, the first network device can send a first response to the second network device. The first response is used to indicate that the first network device allows updating of the quota of terminals corresponding to the first S-NSSAI.

In response to the total number of terminals registered to the network slice corresponding to the first S-NSSAI not reaching the quota, the first network device rejects the first request.

In some embodiments, in response to the total number of terminals registered to the network slice corresponding to the first S-NSSAI reaching the quota, the first network device can perform network slice admission control.

In response to the total number of terminals registered to the network slice corresponding to the first S-NSSAI not reaching the quota, the first network device rejects the first request.

It should be noted that the first network device performing the network slice admission control (NSAC) means that the first network device determines whether to allow the terminal to register to the network slice. That is, the first network device may not update the quota, and the first network device independently determines whether the terminal can register to the network slice when the quota is full.

In addition, it should be noted that, in embodiments of the present disclosure, the total number of terminals registered to the network slice corresponding to the first S-NSSAI reaching the quota means that the total number is consistent with the quota value, or a difference between the total number and the quota value is within an allowed difference range.

In summary, by receiving the first information sent by the third network device and the first request sent by the second network device, the first request is used to request the first network device to process the NSAC request related to the number of terminals corresponding to the first S-NSSAI, determining the total number of terminals registered to the network slice corresponding to the first S-NSSAI according to the first information, and verifying whether the total number of terminals registered to the network slice corresponding to the first S-NSSAI reaches the quota, the core network can determine and verify the number of terminals belonging to a specific network slice, thereby preventing malicious fake requests, effectively maintaining the security of the communication system, and ensuring the communication quality of the system.

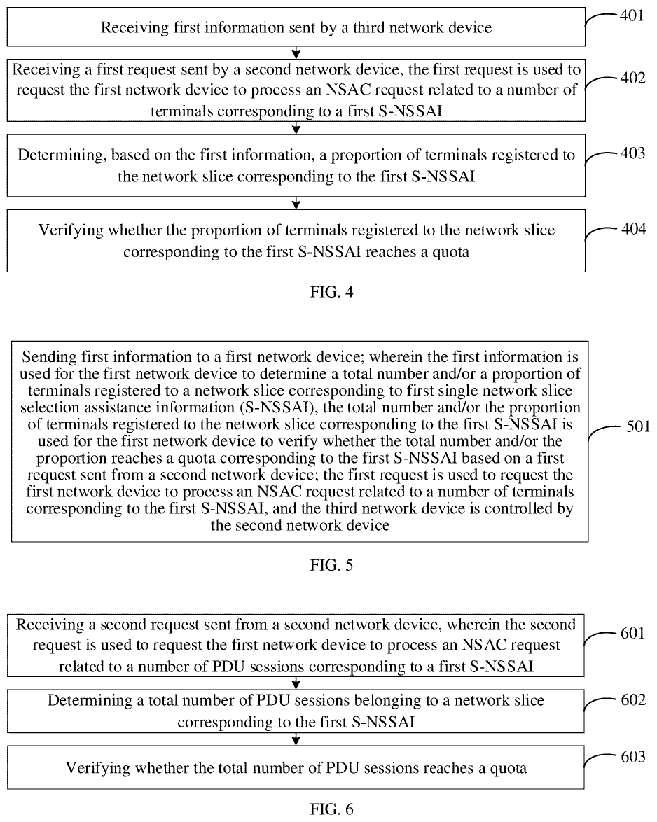

With reference to FIG. 4, FIG. 4 is a flow chart of a communication method based on network slicing provided in an embodiment of the present disclosure. It should be noted that the communication method based on network slicing in embodiments of the present disclosure is performed by a first network device. The method can be performed independently or in combination with any other embodiments of the present disclosure. As shown in FIG. 4, the method may include the following steps.

Step 401, first information sent by a third network device is received.

In embodiments of the present disclosure, the first network device can receive the first information sent by the third network device.

Optionally, the first network device can receive the first information sent when the third network device stores or deletes an allowed NSSAI of a terminal.

It should be noted that the third network device may send the first information due to other reasons.

Optionally, the first information includes at least one of: an identifier of the third network device; an identifier of the second network device; an allowed NSSAI of at least one terminal stored in the third network device; an identifier of the at least one terminal (UE ID); or an access type corresponding to each network slice in the allowed NSSAI, in which the access type comprises 3GPP access and non-3GPP access.

The identifier of the second network device included in the first information is an identifier of the second network device that controls the third network device.

Optionally, the identifier of the second network device may be an NF ID, and the identifier of the third network device may be an NF ID.

It should be noted that the third network device being controlled by the second network device means that the second network device may provide the third network device with availability check and update service of the number of UEs of each network slice (number of UEs per network slice availability check and update service).

In embodiments of the present disclosure, the first network device is a primary NSACF, the second network device is an NSACF controlled by the primary NSACF, and the third network device is an AMF controlled by the NSACF.

Optionally, the first information further includes first instruction information; the first instruction information is used to instruct the first network device to increase or decrease the number of terminals registered to the network slice.

In a case where the third network device stores the allowed NSSAI of the terminal, the first instruction information is used to instruct the first network device to increase the number of terminal (the first instruction information is an increase indicator);

In a case where the third network device deletes the allowed NSSAI of the terminal, the first instruction information is used to instruct the first network device to decrease the number of terminal (the first instruction information is a decrease indicator).

Step 402, a first request sent by a second network device is received, the first request is used to request the first network device to process an NSAC request related to a number of terminals corresponding to a first S-NSSAI.

In embodiments of the present disclosure, the first network device can receive a first request sent by the second network device, the first request is used to request the first network device to process an NSAC request related to a number of terminals corresponding to the first S-NSSAI. For example, the first request is used to request the first network device to increase a quota of terminals corresponding to a first S-NSSAI.

The NSAC request related to the number of terminals refers to availability check and update of the number of UEs per network slice (number of UEs per network slice availability check and update).

Optionally, in embodiments of the present disclosure, the quota of terminals corresponding to the first S-NSSAI is a proportion of terminals allowed to be registered to the network slice corresponding to the first S-NSSAI (UE admission threshold).

In some embodiments, the quota of terminals corresponding to the first S-NSSAI may be the number of terminals allowed to be registered to the network slice corresponding to the first S-NSSAI (maximum number of registered UEs), or the proportion of terminals allowed to be registered to the network slice corresponding to the first S-NSSAI (UE admission threshold).

It can be understood that in embodiments of the present disclosure, the network slice corresponding to the first S-NSSAI is a network slice uniquely identified by the first S-NSSAI.

It should be noted that in embodiments of the present disclosure, the proportion of terminals allowed to be registered to the network slice corresponding to the first S-NSSAI refers to a proportion of the number of terminals allowed to be registered to the network slice corresponding to the first S-NSSAI to a preconfigured total number. The preconfigured total number can be the maximum number of registered UEs or another value, which is not limited in embodiments of the present disclosure. For example, the proportion can be 80%, etc.

It is understandable that in some embodiments, the system may stipulate that the network slice only supports one access type (for example, only supports 3GPP access). Or the system may stipulate that the NSAC procedure does not need to consider the access type. In this case, the first information may not include the access type corresponding to each network slice, and the first network device does not need to perform statistics based on the access type when determining the number of terminals registered to the network slice.

Step 403, a proportion of terminals registered to the network slice corresponding to the first S-NSSAI is determined based on the first information.

In embodiments of the present disclosure, after receiving the first request sent by the second network device, the first network device can determine the proportion of terminals registered to the network slice corresponding to the first S-NSSAI based on the first information received previously.

It can be understood that the ratio is a ratio of the total number of terminals registered to the network slice corresponding to the first S-NSSAI to the preconfigured total number aforementioned.

In some implementations, the proportion of terminals registered to the network slice corresponding to the first S-NSSAI is determined by the first network device according to at least one of the following in the first information: an identifier of the second network device; an allowed NSSAI of at least one terminal stored in the third network device; an identifier of the at least one terminal; or an access type corresponding to each network slice in the allowed NSSAI.

For example, after receiving the first request, the first network device can determine the identifier of the second network device that sends the first request, the first S-NSSAI for which the number of registered terminals needs to be counted, and the access type according to the first request, match to the first information stored locally according to the identifier of the second network device, and count the number of terminals registered to the network slice corresponding to the first S-NSSAI through the access type according to the identifier of the second network device, the allowed NSSAI, an identifier of the terminal, and the access type stored locally. Furthermore, the proportion of terminals registered to the network slice corresponding to the first S-NSSAI can be determined based on the counted number of terminals registered to the network slice corresponding to the first S-NSSAI.

Step 404, it is verified whether the proportion of terminals registered to the network slice corresponding to the first S-NSSAI reaches a quota.

In embodiments of the present disclosure, after determining the proportion of terminals registered to the network slice corresponding to the first S-NSSAI, the first network device can verify whether the proportion of the terminals reaches the quota.

In some embodiments, in response to the proportion of terminals registered to the network slice corresponding to the first S-NSSAI reaching the quota, the first network device can send a first response to the second network device, the first response is used to indicate that the first network device allows updating of the quota of terminals corresponding to the first S-NSSAI;

In response to the proportion of terminals registered to the network slice corresponding to the first S-NSSAI not reaching the quota, the first network device rejects the first request.

In some embodiments, in response to the proportion of terminals registered to the network slice corresponding to the first S-NSSAI reaching the quota, the first network device can perform network slice admission control.

In response to the proportion of terminals registered to the network slice corresponding to the first S-NSSAI not reaching the quota, the first network device rejects the first request.

It should be noted that the first network device performing the network slice admission control (NSAC) means that the first network device determines whether to allow the terminal to register to the network slice. That is, the first network device may not update the quota, and the first network device independently determines whether the terminal can register to the network slice when the quota is full.

In addition, it should be noted that, in embodiments of the present disclosure, the proportion of terminals registered to the network slice corresponding to the first S-NSSAI reaching the quota means that the proportion is consistent with the quota value, or a difference between the proportion and the quota value is within an allowable difference range.

In summary, by receiving the first information sent by the third network device and the first request sent by the second network device, the first request is used to request the first network device to process the NSAC request related to the number of terminals corresponding to the first S-NSSAI, determining the proportion of terminals registered to the network slice corresponding to the first S-NSSAI according to the first information, and verifying whether the proportion of terminals registered to the network slice corresponding to the first S-NSSAI reaches the quota, the core network can determine and verify the number of terminals belonging to a specific network slice, thereby preventing malicious fake requests, effectively maintaining the security of the communication system, and ensuring the communication quality of the system.

With reference to FIG. 5, FIG. 5 is a flow chart of a communication method based on network slicing provided in an embodiment of the present disclosure. It should be noted that the communication method based on network slicing in embodiments of the present disclosure is performed by a third network device. The method can be performed independently or in combination with any other embodiments of the present disclosure. As shown in FIG. 5, the method may include the following steps.

Step 501, first information is sent to a first network device, the first information is used for the first network device to determine a total number and/or a proportion of terminals registered to a network slice corresponding to first single network slice selection assistance information (S-NSSAI), the total number and/or the proportion of terminals registered to the network slice corresponding to the first S-NSSAI is used for the first network device to verify whether the total number and/or the proportion reaches a quota corresponding to the first S-NSSAI after receiving a first request sent from a second network device; the first request is used to request the first network device to process a network slice admission control (NSAC) request related to a number of terminals corresponding to the first S-NSSAI, and the third network device is controlled by the second network device.

In embodiments of the present disclosure, the first network device is a primary NSACF, the second network device is an NSACF controlled by the primary NSACF, and the third network device is an AMF controlled by the NSACF.

In embodiments of the present disclosure, the third network device can send the first information to the first network device when an allowed NSSAI of the terminal is stored or deleted.

Optionally, the first information includes at least one of: an identifier of the third network device; an identifier of the second network device; an allowed NSSAI of at least one terminal stored in the third network device; an identifier of the at least one terminal (UE ID); or an access type corresponding to each network slice in the allowed NSSAI, wherein the access type comprises 3GPP access and non-3GPP access.

The identifier of the second network device included in the first information is an identifier of the second network device that controls the third network device.

Optionally, the identifier of the second network device may be a NF ID, and the identifier of the third network device may be a NF ID.

It should be noted that the third network device being controlled by the second network device means that the second network device may provide the third network device with number of UEs per network slice availability check and update service.

Optionally, the first information further includes first instruction information; the first instruction information is used to instruct the first network device to increase or decrease the number of terminals registered to the network slice.

In a case where the third network device stores an allowed NSSAI of a terminal, the first instruction information is used to instruct the first network device to increase the number of terminals (the first instruction information is an increase indicator);

In a case where the third network device deletes an allowed NSSAI of a terminal, the first instruction information is used to instruct the first network device to decrease the number of terminals (the first instruction information is a decrease indicator).

In embodiments of the present disclosure, the first information can be used by the first network device to determine the total number of terminals registered to the network slice corresponding to the first S-NSSAI, and/or the proportion of terminals registered to the network slice corresponding to the first S-NSSAI.

The total number of terminals registered to the network slice corresponding to the first S-NSSAI, and/or the proportion of terminals registered to the network slice corresponding to the first S-NSSAI, is determined by the first network device according to at least one of the following in the first information: an identifier of the second network device; an allowed NSSAI of at least one terminal stored in the third network device; an identifier of the at least one terminal; or an access type corresponding to each network slice in the allowed NSSAI.

For example, after receiving the first request, the first network device can determine the identifier of the second network device that sends the first request, the first S-NSSAI for which the number of registered terminals needs to be counted, and the access type according to the first request, match to the first information stored locally according to the identifier of the second network device, and count the number of terminals registered to the network slice corresponding to the first S-NSSAI through the access type according to the identifier of the second network device, the allowed NSSAI, the identifier of the terminal, and the access type stored locally. Furthermore, the proportion of terminals registered to the network slice corresponding to the first S-NSSAI can be determined based on the counted number of terminals registered to the network slice corresponding to the first S-NSSAI.

It is understandable that in some embodiments, the system may stipulate that the network slice only supports one access type (for example, only supports 3GPP access). Or the system may stipulate that the NSAC procedure does not need to consider the access type. In this case, the first information may not include the access type corresponding to each network slice, and the first network device does not need to perform statistics based on the access type when determining the number of terminals registered to the network slice.

In embodiments of the present disclosure, the first request is sent from the second network device to the first network device, and is used to request the first network device to process the NSAC request related to the number of terminals corresponding to the first S-NSSAI.

The NSAC request related to the number of terminals refers to the availability check and update of the number of UEs per network slice (number of UEs per network slice availability check and update).

Optionally, a quota of terminals corresponding to the first S-NSSAI may be the number of terminals allowed to be registered to the network slice corresponding to the first S-NSSAI (maximum number of registered UEs), or the proportion of terminals allowed to be registered to the network slice corresponding to the first S-NSSAI (UE admission threshold).

It can be understood that in embodiments of the present disclosure, the network slice corresponding to the first S-NSSAI is a network slice uniquely identified by the first S-NSSAI.

In summary, by sending the first information to the first network device, in which the first information is used by the first network device to determine the total number and/or the proportion of terminals registered to the network slice corresponding to the first S-NSSAI; the total number and/or the proportion of terminals registered to the network slice corresponding to the first S-NSSAI is used by the first network device to verify whether the quota corresponding to the first S-NSSAI is reached after receiving the first request sent by the second network device; the first request is used to request the first network device to process the NSAC request related to the number of terminals corresponding to the first S-NSSAI, and the third network device is controlled by the second network device, the core network can determine and verify the number of terminals belonging to a specific network slice, thereby preventing malicious fake requests, effectively maintaining the security of the communication system, and ensuring the communication quality of the system.

With reference to FIG. 6, FIG. 6 is a flow chart of a communication method based on network slicing provided in an embodiment of the present disclosure. It should be noted that the communication method based on network slicing in embodiments of the present disclosure is performed by a first network device. The method can be performed independently or in combination with any other embodiments of the present disclosure. As shown in FIG. 6, the method can include the following steps.

Step 601, a second request sent by a second network device is received, in which the second request is used to request the first network device to process an NSAC request related to a number of PDU sessions corresponding to a first S-NSSAI.

In embodiments of the present disclosure, the first network device can receive the second request sent by the second network device, in which the second request is used to request the first network device to process the NSAC request related to the number of PDU sessions corresponding to the first S-NSSAI.

The NSAC request related to the number of PDU sessions refers to availability check and update of a number of PDU sessions for a network slice (number of PDU sessions per network slice availability check and update).

In embodiments of the present disclosure, the first network device is a primary NSACF, and the second network device is an NSACF under the control of the primary NSACF.

Optionally, a quota of the number of PDU sessions corresponding to the first S-NSSAI may be a number of PDU sessions allowed to be established in the network slice corresponding to the first S-NSSAI.

It can be understood that in embodiments of the present disclosure, the network slice corresponding to the first S-NSSAI is a network slice uniquely identified by the first S-NSSAI.

Step 602, a total number of PDU sessions belonging to a network slice corresponding to the first S-NSSAI is determined.

In embodiments of the present disclosure, the first network device can determine the total number of PDU sessions belonging to the network slice corresponding to the first S-NSSAI.

In some embodiments, the first network device can determine the total number of PDU sessions belonging to the network slice corresponding to the first S-NSSAI based on second information sent to the first network device by a fourth network device.

The fourth network device is controlled by the second network device.

In embodiments of the present disclosure, the fourth network device is a session management function (SMF).

It should be noted that the fourth network device being controlled by the second network device means that the second network device may provide the fourth network device with an availability check and update service of a number of PDU sessions for a network slice (number of PDU sessions per network slice availability check and update service).

Optionally, the second information includes at least one of: an identifier of the fourth network device; an identifier of the second network device; an identifier of at least one terminal (UE ID); an identifier of at least one PDU session established for the at least one terminal; an S-NSSAI corresponding to each PDU session; or an access type corresponding to a network slice that corresponds to each S-NSSAI, in which the access type comprises 3GPP access and non-3GPP access.

Optionally, the identifier of the second network device may be an NF ID, and the identifier of the fourth network device may be an NF ID.

The total number of PDU sessions belonging to the network slice corresponding to the first S-NSSAI is determined according to at least one of the following in the second information: an identifier of the second network device; an identifier of at least one terminal; an identifier of at least one PDU session established for the at least one terminal; an access type corresponding to a network slice that corresponds to each S-NSSAI.

For example, after receiving the second request, the first network device can determine the identifier of the second network device that sends the second request, the first S-NSSAI for which the number of registered terminals needs to be counted, and the access type according to the second request, match to the second information stored locally according to the identifier of the second network device, and count the number of PDU sessions established for a terminal registered to the network slice corresponding to the first S-NSSAI through the access type according to the identifier of the second network device, the identifier of the terminal, the identifier of at least one PDU session established for the terminal, and the access type locally stored.

It is understandable that in some embodiments, the system may stipulate that the network slice only supports one access type (for example, only supports 3GPP access). Or the system may stipulate that the NSAC procedure does not need to consider the access type. In this case, the second information may not include the access type corresponding to each network slice, and the first network device does not need to perform statistics based on the access type when determining the number of PDU sessions belonging to the network slice.

Optionally, the second information also includes second instruction information; the second instruction information is used to instruct the first network device to increase or decrease the number of PDU sessions belonging to the network slice.

In the case where the fourth network device establishes a PDU session for the terminal, the second instruction information is used to instruct the first network device to increase the number of PDU sessions (the second instruction information is an increase indicator).

In the case where the fourth network device releases a PDU session for the terminal, the second instruction information is used to instruct the first network device to decrease the number of PDU sessions (the second instruction information is a decrease indicator).

Step 603, it is verified whether the total number of PDU sessions reaches a quota.

In embodiments of the present disclosure, after determining the total number of PDU sessions belonging to the network slice corresponding to the first S-NSSAI, the first network device can verify whether the total number of PDU sessions reaches the quota.

In some embodiments, in response to the total number of PDU sessions reaching the quota, the first network device can send a second response to the second network device, the second response being used to indicate that the first network device allows updating the quota of the numbers of PDU sessions in the first S-NSSAI.

In response to the total number of PDU sessions not reaching the quota, the first network device can reject the second request.

In some embodiments, in response to the total number of PDU sessions reaching the quota, the first network device can perform network slice admission control.

In response to the total number of PDU sessions not reaching the quota, the first network device can reject the second request.

It should be noted that the first network device performing the NSAC means that the first network device determines whether to allow establishing a PDU session toward the network slice. That is, the first network device may not update the quota, and the first network device independently determines whether a PDU session toward the network slice can be established for the terminal when the quota is full.

In addition, it should be noted that in embodiments of the present disclosure, the total number of PDU sessions belonging to the first S-NSSAI reaching the quota means that the total number is consistent with the quota value, or a difference between the total number and the quota is within an allowed difference range.

In summary, by receiving the second request sent by the second network device, the second request is used to request the first network device to process the NSAC request related to the number of PDU sessions corresponding to the first S-NSSAI, determining the total number of PDU sessions belonging to the network slice corresponding to the first S-NSSAI, and verifying whether the total number of PDU sessions reaches the quota, the core network can determine and verify the number of established PDU sessions belonging to a specific network slice, thereby preventing malicious fake requests, effectively maintaining the security of the communication system, and ensuring the communication quality of the system.

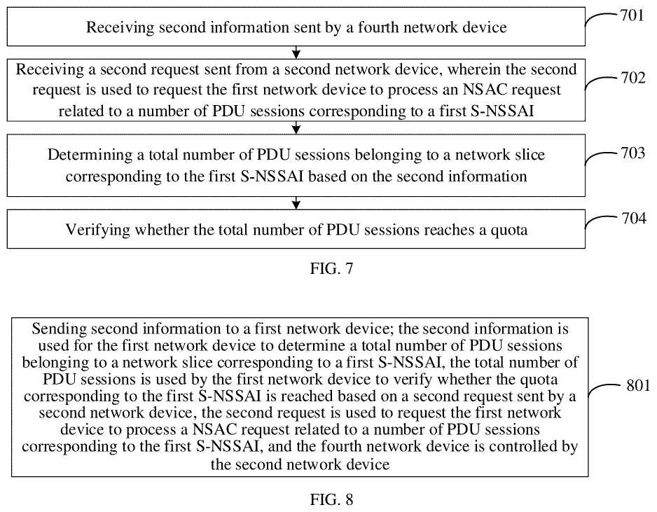

With reference to FIG. 7, FIG. 7 is a flow chart of a communication method based on network slicing provided in an embodiment of the present disclosure. It should be noted that the communication method based on network slicing in embodiments of the present disclosure is performed by a first network device. The method can be performed independently or in combination with any other embodiments of the present disclosure. As shown in FIG. 7, the method may include the following steps.

Step 701, second information sent by a fourth network device is received.

In embodiments of the present disclosure, the first network device can receive the second information sent by the fourth network device. The first network device can receive the second information sent when the fourth network device establishes a PDU session for a terminal or releases a PDU session.

Optionally, the second information includes at least one of: an identifier of the fourth network device; an identifier of the second network device; an identifier of at least one terminal (UE ID); an identifier of at least one PDU session established for the at least one terminal; an S-NSSAI corresponding to each PDU session; or an access type corresponding to a network slice that corresponds to each S-NSSAI, in which the access type comprises 3GPP access and non-3GPP access.

The identifier of the second network device included in the second information is an identifier of the second network device that controls the fourth network device.

Optionally, the identifier of the second network device may be an NF ID, and the identifier of the fourth network device may be an NF ID.

It should be noted that the fourth network device being controlled by the second network device means that the second network device needs to provide the fourth network device with number of PDU sessions per network slice availability check and update service.

In embodiments of the present disclosure, the first network device is a primary NSACF, the second network device is an NSACF controlled by the primary NSACF, and the fourth network device is an SMF controlled by the NSACF.

Optionally, the second information further includes second instruction information; the second instruction information is used to instruct the first network device to increase or decrease the number of PDU sessions belonging to the network slice.

In the case where the fourth network device establishes a PDU session for a terminal, the second instruction information is used to instruct the first network device to increase the number of PDU session (the second instruction information is an increase indicator);

In the case where the fourth network device releases a PDU session for a terminal, the second instruction information is used to instruct the first network device to decrease the number of PDU sessions (the second instruction information is a decrease indicator).

Step 702, a second request sent by a second network device is received, the second request is used to request the first network device to process an NSAC request related to a number of PDU sessions corresponding to first S-NSSAI.

In embodiments of the present disclosure, the first network device can receive the second request sent by the second network device, the second request is used to request the first network device to process the NSAC request related to the number of PDU sessions corresponding to the first S-NSSAI.

Optionally, a quota of the number of PDU sessions corresponding to the first S-NSSAI may be a number of PDU sessions allowed to be established in the network slice corresponding to the first S-NSSAI.

The NSAC request related to the number of PDU sessions refers to availability check and update of the number of PDU sessions of a network slice (number of PDU sessions per network slice availability check and update).

Optionally, the quota of the number of PDU sessions corresponding to the first S-NSSAI may be a number of PDU sessions allowed to be established in the network slice corresponding to the first S-NSSAI.

It can be understood that in embodiments of the present disclosure, the network slice corresponding to the first S-NSSAI is a network slice uniquely identified by the first S-NSSAI.

Step 703, a total number of PDU sessions belonging to a network slice corresponding to the first S-NSSAI is determined based on the second information.

In embodiments of the present disclosure, after receiving the second request sent by the second network device, the first network device can determine the total number of PDU sessions belonging to the network slice corresponding to the first S-NSSAI based on the second information previously received.

In some implementations, the total number of PDU sessions belonging to the network slice corresponding to the first S-NSSAI is determined according to at least one of the following in the second information: an identifier of the second network device; an identifier of at least one terminal; an identifier of at least one PDU session established for the at least one terminal; or an access type corresponding to a network slice that corresponds to each S-NSSAI.

For example, after receiving the second request, the first network device can determine the identifier of the second network device that sends the second request, the first S-NSSAI for which a number of registered terminals needs to be counted, and the access type according to the second request, match to the second information stored locally according to the identifier of the second network device, and count the number of PDU sessions established for terminals registered to the network slice corresponding to the first S-NSSAI through the access type according to the identifier of the second network device, the identifier of the terminal, the identifier of at least one PDU session established for the terminal, and the access type locally stored.

It is understandable that, in some embodiments, the system may stipulate that the network slice only supports one access type (for example, only supports 3GPP access). Or the system may stipulate that the NSAC procedure does not need to consider the access type. In this case, the second information may not include the access type corresponding to each network slice, and the first network device does not need to perform statistics based on the access type when determining the number of PDU sessions belonging to the network slice.

Step 704, it is verified whether the total number of PDU sessions reaches a quota.

In embodiments of the present disclosure, after determining the total number of PDU sessions belonging to the network slice corresponding to the first S-NSSAI, the first network device can verify whether the total number of PDU sessions reaches the quota.

In some embodiments, in response to the total number of the PDU sessions reaching the quota, the first network device can send a second response to the second network device, the second response being used to indicate that the first network device allows updating the quota of the number of PDU sessions in the first S-NSSAI.

In response to the total number of PDU sessions not reaching the quota, the first network device can reject the second request.

In some embodiments, in response to the total number of PDU sessions reaching the quota, the first network device can perform network slice admission control.

In response to the total number of PDU sessions not reaching the quota, the first network device can reject the second request.

It should be noted that the first network device performing the network slice admission control (NSAC) means that the first network device determines whether to allow establishing a PDU session toward the network slice. That is, the first network device may not update the quota, and the first network device independently determines whether to establish a PDU session toward the network slice for the terminal when the quota is full.

In addition, it should be noted that in embodiments of the present disclosure, the total number of PDU sessions belonging to the first S-NSSAI reaching the quota means that the total number is consistent with the quota value, or a difference between the total number and the quota is within an allowed difference range.

In summary, by receiving the second information sent by the fourth network device, receiving the second request sent by the second network device, in which the second request is used to request the first network device to process the NSAC request related to the number of PDU sessions corresponding to the first S-NSSAI, determining the total number of PDU sessions belonging to the network slice corresponding to the first S-NSSAI according to the second information, and verifying whether the total number of PDU sessions reaches the quota, the core network can determine and verify the number of established PDU sessions belonging to a specific network slice, thereby preventing malicious fake requests, effectively maintaining the security of the communication system, and ensuring the communication quality of the system.

With reference to FIG. 8, FIG. 8 is a flow chart of a communication method based on network slicing provided in an embodiment of the present disclosure. It should be noted that the communication method based on network slicing in embodiments of the present disclosure is performed by a fourth network device. The method can be performed independently or in combination with any other embodiments of the present disclosure. As shown in FIG. 8, the method may include the following steps.

Step 801, second information is sent to a first network device; the second information is used for the first network device to determine a total number of PDU sessions belonging to a network slice corresponding to a first S-NSSAI, the total number of PDU sessions is used by the first network device to verify whether the quota corresponding to the first S-NSSAI is reached after receiving a second request sent by a second network device, the second request is used to request the first network device to process a NSAC request related to a number of PDU sessions corresponding to the first S-NSSAI, and the fourth network device is controlled by the second network device.

In embodiments of the present disclosure, the first network device is a primary NSACF, the second network device is an NSACF controlled by the primary NSACF, and the fourth network device is an SMF controlled by the NSACF.

In embodiments of the present disclosure, the fourth network device can send the second information to the first network device when establishing or releasing a PDU session for a terminal.

Optionally, the second information includes at least one of: an identifier of the fourth network device; an identifier of the second network device; an identifier of at least one terminal (UE ID); an identifier of at least one PDU session established for the at least one terminal; an S-NSSAI corresponding to each PDU session; or an access type corresponding to a network slice that corresponds to each S-NSSAI, in which the access type comprises 3GPP access and non-3GPP access.

The identifier of the second network device included in the second information is an identifier of the second network device that controls the fourth network device.

Optionally, the identifier of the second network device may be an NF ID (Network Function ID), and the identifier of the fourth network device may be an NF ID (Network Function ID).

It should be noted that the fourth network device being controlled by the second network device means that the second network device needs to provide the fourth network device with a availability check and update service of a number of PDU sessions per network slice (number of PDU sessions per network slice availability check and update service).

Optionally, the second information further includes second instruction information; the second instruction information is used to instruct the first network device to increase or decrease the number of PDU sessions belonging to the network slice.

In the case where the fourth network device establishes a PDU session for the terminal, the second instruction information is used to instruct the first network device to increase the number of PDU sessions (the second instruction information is an increase indicator).

In the case where the fourth network device releases a PDU session for the terminal, the second instruction information is used to instruct the first network device to decrease the number of PDU sessions (the second instruction information is a decrease indicator).

In embodiments of the present disclosure, the second information can be used by the first network device to determine the total number of PDU sessions belonging to the network slice corresponding to the first S-NSSAI.

The total number of PDU sessions belonging to the network slice corresponding to the first S-NSSAI is determined according to at least one of the following in the second information: an identifier of the second network device; an identifier of at least one terminal; an identifier of at least one PDU session established for the at least one terminal; or an access type corresponding to a network slice that corresponds to each S-NSSAI.

For example, after receiving the second request, the first network device can determine the identifier of the second network device that sends the second request, the first S-NSSAI for which a number of registered terminals needs to be counted, and the access type according to the second request, match to the second information stored locally according to the identifier of the second network device, and count the number of PDU sessions established for the terminals registered to the network slice corresponding to the first S-NSSAI through the access type according to the identifier of the second network device, the identifier of the terminal, the identifier of the at least one PDU session established for the terminal, and the access type locally stored.

It is understandable that, in some embodiments, the system may stipulate that the network slice only supports one access type (for example, only supports 3GPP access). Or the system may stipulate that the NSAC procedure does not need to consider the access type. In this case, the second information may not include the access type corresponding to each network slice, and the first network device does not need to perform statistics based on the access type when determining the number of PDU sessions belonging to the network slice.

In embodiments of the present disclosure, the second request is sent by the second network device to the first network device, and is used to request the first network device to process an NSAC request related to the number of PDU sessions corresponding to the first S-NSSAI.

The NSAC request related to the number of PDU sessions refers to availability check and update of the number of PDU sessions of a network slice (number of PDU sessions per network slice availability check and update).

Optionally, the quota of the number of PDU sessions corresponding to the first S-NSSAI may be a number of PDU sessions allowed to be established in the network slice corresponding to the first S-NSSAI.

It can be understood that in embodiments of the present disclosure, the network slice corresponding to the first S-NSSAI is a network slice uniquely identified by the first S-NSSAI.

In summary, by sending the second information to the first network device; in which the second information is used by the first network device to determine the total number of PDU sessions belonging to the network slice corresponding to the first S-NSSAI, the total number of PDU sessions is used by the first network device to verify whether the quota corresponding to the first S-NSSAI is reached after receiving the second request sent by the second network device, the second request is used to request the first network device to process the NSAC request quota related to the number of PDU sessions corresponding to the first S-NSSAI, and the fourth network device is controlled by the second network device, the core network can determine and verify the number of established PDU sessions belonging to a specific network slice, thereby preventing malicious fake requests, effectively maintaining the security of the communication system, and ensuring the communication quality of the system.

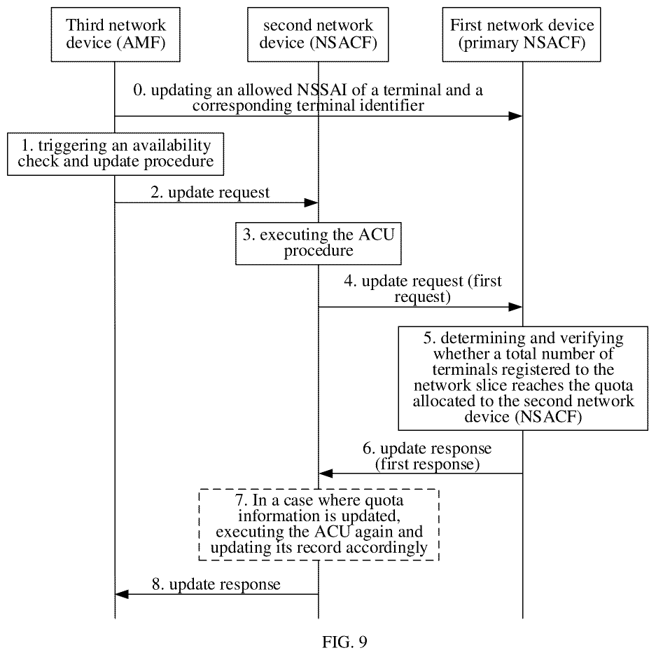

With reference to FIG. 9, FIG. 9 is a flow chart of a communication method based on network slicing provided in an embodiment of the present disclosure. The method can be performed independently or in combination with any other embodiments of the present disclosure. As shown in FIG. 9, the method may include the following steps.

0. A third network device (AMF) updates an allowed NSSAI of a terminal and a corresponding terminal identifier to a first network device (primary NSACF).

The third network device (AMF) can send first information to the first network device when third network device (AMF) stores or deletes the allowed NSSAI of the terminal.

Optionally, the first information includes at least one of: an identifier of the third network device; an identifier of a second network device (NSACF) that controls the third network device; an allowed NSSAI of at least one terminal stored in the third network device; an identifier of the at least one terminal (UE ID); or an access type corresponding to each network slice in the allowed NSSAI, in which the access type comprises 3GPP access and non-3GPP access

Optionally, the identifier of the second network device may be an NF ID (Network Function ID), and the identifier of the third network device may be an NF ID (Network Function ID).

Optionally, the first information further includes first instruction information; the first instruction information is used to instruct the first network device to increase or decrease a number of terminals registered to the network slice.

In a case where the third network device stores an allowed NSSAI of the terminal, the first instruction information is used to instruct the first network device to increase a number of terminals (the first instruction information is an increase indicator).

In a case where the third network device deletes an allowed NSSAI of the terminal, the first instruction information is used to instruct the first network device to decrease a number of terminals (the first instruction information is a decrease indicator).

1. The third network device (AMF) triggers an availability check and update (ACU) procedure.

2. The third network device (AMF) sends an update request to the second network device (NSACF).

3. The second network device (NSACF) executes the ACU procedure according to its locally stored quota.

4. Based on a local configuration, the second network device (NSACF) may send an update request (first request) for availability check and update to the first network device (primary NSACF).

5. The first network device (primary NSACF) determines and verifies whether a total number of terminals registered to the network slice reaches the quota allocated to the second network device (NSACF).

In embodiments of the present disclosure, the quota is a maximum number of terminals allowed to be registered to the network slice corresponding to the first S-NSSAI (maximum number of registered UEs). The first network device can determine the total number of terminals registered to the network slice corresponding to the first S-NSSAI based on the first information, and verify whether the total number of terminals reaches the quota.

For example, after receiving the first request, the first network device can determine the identifier of the second network device that sends the first request, the first S-NSSAI for which a number of registered terminals needs to be counted, and an access type according to the first request, match to the first information stored locally according to the identifier of the second network device, and count the number of terminals registered to the network slice corresponding to the first S-NSSAI through the access type according to the identifier of the second network device, the allowed NSSAI, the identifier of the terminal, and the access type locally stored.

6. The first network device (primary NSACF) sends a first response to the second network device (NSACF).

In some implementations, the first response sent by the first network device (primary NSACF) may provide an updated quota if necessary.

In some embodiments, the first network device (primary NSACF) does not provide an updated quota, instead, the first network device performs an NSAC procedure and forwards a result of the NSAC procedure to the second network device (NSACF).

7. In a case where quota information is updated, the second network device (NSACF) may execute the ACU again and update its record accordingly.

It is understandable that, in some implementations, if the first network device (primary NSACF) does not provide an updated quota, the second network device (NSACF) does not perform step 7.

8. The second network device (NSACF) sends an update response to the third network device (AMF).

In some embodiments, the first network device (primary NSACF) does not provide an updated quota, instead it executes the NSAC procedure and forwards the result of the NSAC procedure to the second network device (NSACF), and the second network device (NSACF) then forwards the result of the NSAC procedure to the third network device (AMF).

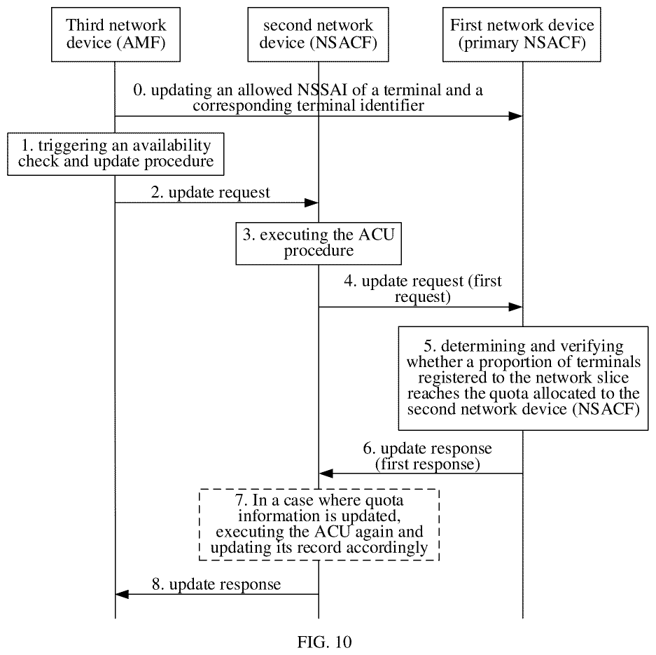

With reference to FIG. 10, FIG. 10 is a flow chart of a communication method based on network slicing provided in an embodiment of the present disclosure. The method can be performed independently or in combination with any other embodiments of the present disclosure. As shown in FIG. 10, the method may include the following steps.

0. A third network device (AMF) updates an allowed NSSAI of a terminal and a corresponding terminal identifier to a first network device (primary NSACF).

The third network device (AMF) can send first information to the first network device when the allowed NSSAI of the terminal is stored or deleted.

Optionally, the first information includes at least one of: an identifier of the third network device; an identifier of a second network device (NSACF) that controls the third network device; an allowed NSSAI of at least one terminal stored in the third network device; an identifier of the at least one terminal (UE ID); or an access type corresponding to each network slice in the allowed NSSAI, wherein the access type comprises 3GPP access and non-3GPP access.

Optionally, the identifier of the second network device may be an NF ID (Network Function ID), and the identifier of the third network device may be an NF ID (Network Function ID).

Optionally, the first information also includes first instruction information; the first instruction information is used to instruct the first network device to increase or decrease a number of terminals registered to the network slice.

In a case where the third network device stores an allowed NSSAI of a terminal, the first instruction information is used to instruct the first network device to increase the number of terminals (the first instruction information is an increase indicator);

In a case where the third network device deletes an allowed NSSAI of a terminal, the first instruction information is used to instruct the first network device to decrease the number of terminals (the first instruction information is a decrease indicator).

1. The third network device (AMF) triggers an availability check and update (ACU) procedure.

2. The third network device (AMF) sends an update request to the second network device (NSACF).

3. The second network device (NSACF) executes the ACU procedure according to its locally stored quota.

4. Based on a local configuration, the second network device (NSACF) may send an update request (first request) for availability check and update to the first network device (primary NSACF).

5. The first network device (primary NSACF) determines and verifies whether a proportion of terminals registered to the network slice reaches the quota allocated to the second network device (NSACF).

In embodiments of the present disclosure, the quota is the proportion of terminals allowed to be registered to the network slice corresponding to the first S-NSSAI (UE admission threshold). The first network device can determine the proportion of terminals registered to the network slice corresponding to the first S-NSSAI based on the first information, and verify whether the total number of terminals reaches the quota.

For example, after receiving the first request, the first network device can determine the identifier of the second network device that sends the first request, the first S-NSSAI for which the number of registered terminals needs to be counted, and the access type according to the first request, match to the first information stored locally according to the identifier of the second network device, and count the number of terminals registered to the network slice corresponding to the first S-NSSAI through the access type according to the identifier of the second network device, the allowed NSSAI, the identifier of the terminal, and the access type stored locally. Furthermore, the proportion of terminals registered to the network slice corresponding to the first S-NSSAI can be determined based on the counted number of terminals registered to the network slice corresponding to the first S-NSSAI.

6. The first network device (primary NSACF) sends a first response to the second network device (NSACF).

In some implementations, the first response sent by the first network device (primary NSACF) may provide an updated quota if necessary.

In some embodiments, the first network device (primary NSACF) does not provide an updated quota, instead the first network device performs an NSAC procedure and forwards a result of the NSAC procedure to the second network device (NSACF).

7. In a case where the quota information is updated, the second network device (NSACF) may execute the ACU again and update its record accordingly.

It is understandable that, in some implementations, if the first network device (primary NSACF) does not provide an updated quota, the second network device (NSACF) does not perform step 7.

8. The second network device (NSACF) sends an update response to the third network device (AMF).

In some embodiments, the first network device (primary NSACF) does not provide an updated quota, instead the first network device executes an NSAC procedure and forwards a result of the NSAC procedure to the second network device (NSACF), and the second network device (NSACF) then forwards the result of the NSAC procedure to the third network device (AMF).

With reference to FIG. 11, FIG. 11 is a flow chart of a communication method based on network slicing provided in embodiments of the present disclosure. The method can be performed independently or in combination with any other embodiments of the present disclosure. As shown in FIG. 11, the method may include the following steps.

0. The fourth network device (SMF) updates an identifier of a PDU session established for a terminal and an identifier of the terminal to a first network device (primary NSACF).

The fourth network device (SMF) can send second information to the first network device when establishing or releasing a PDU session for the terminal.

Optionally, the second information includes at least one of: an identifier of the fourth network device; an identifier of a second network device that controls the fourth network device; an identifier of at least one terminal (UE ID); an identifier of at least one PDU session established for the at least one terminal; an S-NSSAI corresponding to each PDU session; or an access type corresponding to a network slice that corresponds to each S-NSSAI, in which the access type comprises 3GPP access and non-3GPP access.

Optionally, the identifier of the second network device may be an NF ID (Network Function ID), and the identifier of the fourth network device may be an NF ID (Network Function ID).

Optionally, the second information also includes second instruction information; the second instruction information is used to instruct the first network device to increase or decrease a number of PDU sessions belonging to the network slice.

In a case where the fourth network device establishes a PDU session for the terminal, the second instruction information is used to instruct the first network device to increase the number of PDU sessions (the second instruction information is an increase indicator);

In a case where the fourth network device releases the PDU session for the terminal, the second instruction information is used to instruct the first network device to decrease the number of PDU sessions (the second instruction information is a decrease indicator).

1. The fourth network device (SMF) triggers an availability check and update (ACU) procedure.

2. The fourth network device (SMF) sends an update request to a second network device (NSACF).

3. The second network device (NSACF) executes the ACU procedure according to its locally stored quota.

4. Based on a local configuration, the second network device (NSACF) may send an update request (second request) for availability check and update to the first network device (primary NSACF).

5. The first network device (primary NSACF) determines and verifies whether a total number of PDU sessions belonging to a network slice reaches a quota allocated to the second network device (NSACF).

In embodiments of the present disclosure, the quota is a maximum number of PDU sessions allowed to be established in the network slice corresponding to the first S-NSSAI. The first network device can determine the total number of PDU sessions belonging to the network slice corresponding to the first S-NSSAI based on the second information, and verify whether the total number of PDU sessions reaches the quota.

For example, after receiving the second request, the first network device can determine the identifier of the second network device that sends the second request, the first S-NSSAI for which a number of registered terminals needs to be counted, and the access type according to the second request, match to the second information stored locally according to the identifier of the second network device, and count the number of PDU sessions established for terminals registered to the network slice corresponding to the first S-NSSAI through the access type according to the identifier of the second network device, the identifier of the terminal, the identifier of at least one PDU session established for the terminal, and the access type locally stored.

6. The first network device (primary NSACF) sends a second response to the second network device (NSACF).

In some implementations, the second response sent by the first network device (primary NSACF) may provide an updated quota if necessary.

In some embodiments, the first network device (primary NSACF) does not provide an updated quota, instead the first network device performs an NSAC procedure and forwards a result of the NSAC procedure to the second network device (NSACF).

7. In case the quota information is updated, the second network device (NSACF) may execute the ACU again and update its record accordingly.

It is understandable that, in some implementations, if the first network device (primary NSACF) does not provide an updated quota, the second network device (NSACF) does not perform step 7.

8. The second network device (NSACF) sends an update response to the fourth network device (SMF).

In some embodiments, the first network device (primary NSACF) does not provide an updated quota, instead the first network device executes an NSAC procedure and forwards the result of the NSAC procedure to the second network device (NSACF), and the second network device (NSACF) then forwards the result of the NSAC procedure to the fourth network device (SMF).

Corresponding to the communication method based on network slicing provided in the above-mentioned embodiments, the present disclosure also provides a communication device based on network slicing. Since the communication device based on network slicing provided in embodiments of the present disclosure corresponds to the methods provided in the above-mentioned embodiments, the implementation of the communication method based on network slicing is also applicable to the communication device based on network slicing provided in the following embodiments, and are not described in detail in the following embodiments.

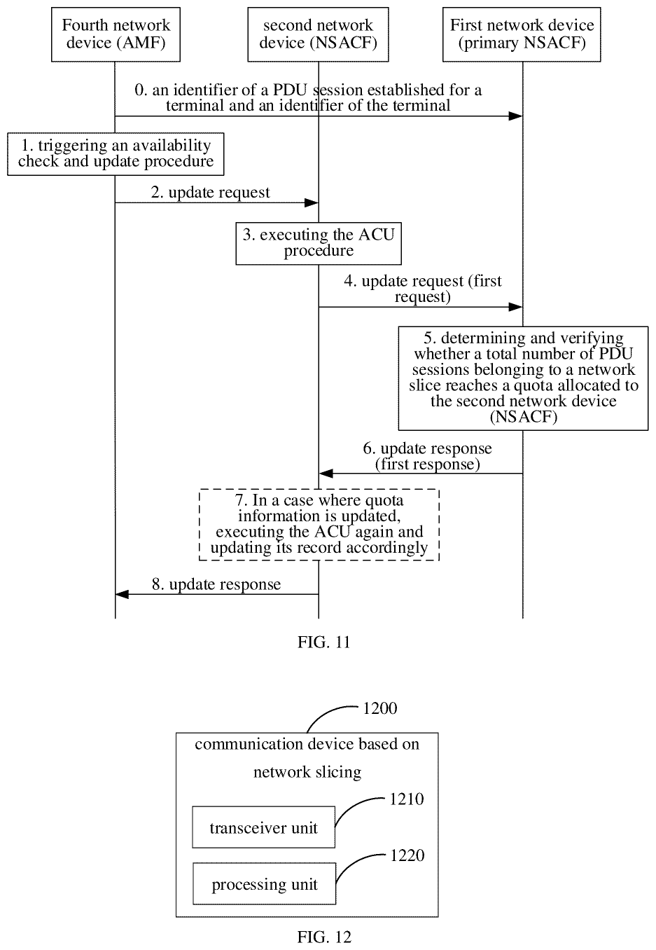

With reference to FIG. 12, FIG. 12 is a structural diagram of a communication device based on network slicing provided in embodiments of the present disclosure.

As shown in FIG. 12, the communication device 1200 based on network slicing includes: a transceiver unit 1210 and a processing unit 1220.

The transceiver unit 1210 is configured to receive a first request sent from a second network device, wherein the first request is used to request the first network device to process a network slice admission control (NSAC) request related to a number of terminals corresponding to first single network slice selection assistance information (S-NSSAI).

The processing unit 1220 is configured to verify whether a total number of terminals registered to a network slice corresponding to the first S-NSSAI and/or a proportion of terminals registered to a network slice corresponding to the first S-NSSAI reaches a quota.

Optionally, the processing unit 1220 is further configured to: determine the total number of terminals registered to the network slice corresponding to the first S-NSSAI and/or the proportion of terminals registered to the network slice corresponding to the first S-NSSAI

Optionally, the processing unit 1220 is configured to: determine, according to first information sent from a third network device to the first network device, the total number and/or the proportion of the terminals registered to the network slice corresponding to the first S-NSSAI, wherein the third network device is controlled by the second network device.

Optionally, the first information includes at least one of: an identifier of the third network device; an identifier of the second network device; an allowed NSSAI of at least one terminal stored in the third network device; an identifier of the at least one terminal; or an access type corresponding to each network slice in the allowed NSSAI, wherein the access type comprises 3GPP access and non-3GPP access.

Optionally, the total number and/or the proportion of the terminals registered to the network slice corresponding to the first S-NSSAI is determined according to at least one of the following in the first information: an identifier of the second network device; an allowed NSSAI of at least one terminal stored in the third network device; an identifier of the at least one terminal; or an access type corresponding to each network slice in the allowed NSSAI.

Optionally, the first information also includes first instruction information.

The first instruction information is used to instruct the first network device to increase or decrease a number of terminals registered to the network slice.

Optionally, in a case where the third network device stores an allowed NSSAI of a terminal, the first instruction information is used to instruct the first network device to increase the number of terminals.

In a case where the third network device deletes an allowed NSSAI of a terminal, the first instruction information is used to instruct the first network device to decrease the number of terminals.

Optionally, the processing unit 1220 is further configured to: in response to the total number of terminals registered to the network slice corresponding to the first S-NSSAI reaching the quota, and/or in response to the proportion of terminals registered to the network slice corresponding to the first S-NSSAI reaching the quota, send a first response to the second network device, wherein the first response indicates that the first network device allows updating the quota of the terminals corresponding to the first S-NSSAI; in response to the total number of terminals registered to the network slice corresponding to the first S-NSSAI not reaching the quota, and/or in response to the proportion of terminals registered to the network slice corresponding to the first S-NSSAI not reaching the quota, reject the first request.

Optionally, the processing unit 1220 is further configured to: in response to the total number of terminals registered to the network slice corresponding to the first S-NSSAI reaching the quota, and/or in response to the proportion of terminals registered to the network slice corresponding to the first S-NSSAI reaching the quota, perform network slice admission control; in response to the total number of terminals registered to the network slice corresponding to the first S-NSSAI not reaching the quota, and/or in response to the proportion of terminals registered to the network slice corresponding to the first S-NSSAI not reaching the quota, reject the first request.

Optionally, the first network device is a primary NSACF, the second network device is an NSACF, and the third network device is an AMF.

The communication device based on network slicing according to embodiments of the disclosure can receive the first request sent by the second network device, the first request is used to request the first network device to process the NSAC request related to the number of terminals corresponding to the first S-NSSAI, and verify whether the total number of terminals registered to the network slice corresponding to the first S-NSSAI and/or the proportion of terminals registered to the network slice corresponding to the first S-NSSAI reaches the quota, so that the core network can determine and verify the number of terminals belonging to a specific network slice, thereby preventing malicious fake requests, effectively maintaining the security of the communication system, and ensuring the communication quality of the system.

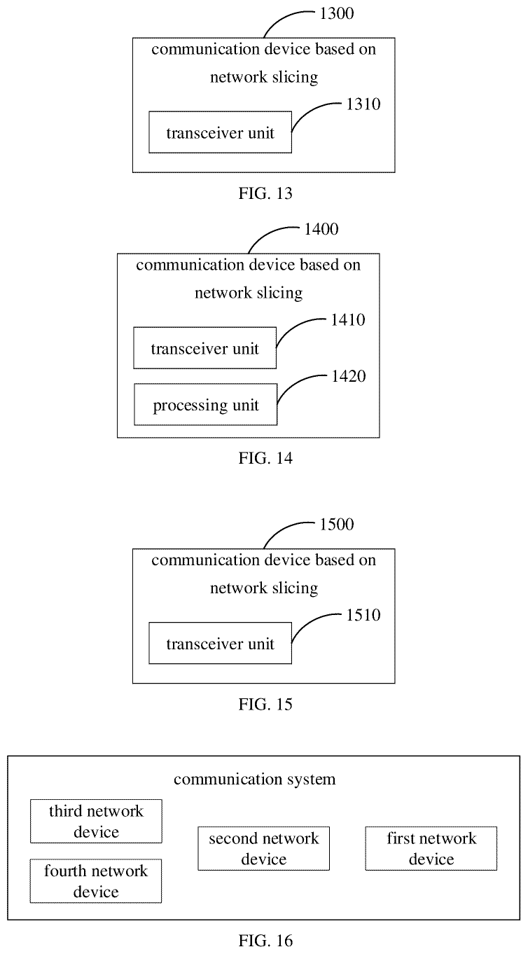

With reference to FIG. 13, FIG. 13 is a structural diagram of a communication device based on network slicing provided in embodiments of the present disclosure.

As shown in FIG. 13, the communication device 1300 based on network slicing includes a transceiver unit 1310.

The transceiver unit 1310 is configured to send first information to a first network device; wherein the first information is used for the first network device to verify whether a total number and/or a proportion of terminals registered to a network slice corresponding to first single network slice selection assistance information (S-NSSAI) reaches a quota corresponding to the first S-NSSAI after receiving a first request sent from a second network device; the first request is used to request the first network device to process a network slice admission control (NSAC) request related to a number of terminals corresponding to the first S-NSSAI, and the third network device is controlled by the second network device.

Optionally, the first information is used by the first network device to determine the total number of terminals registered to the network slice corresponding to the first S-NSSAI and/or the proportion of terminals registered to the network slice corresponding to the first S-NSSAI.

Optionally, the first information includes at least one of: an identifier of the third network device; an identifier of the second network device; an allowed NSSAI of at least one terminal stored in the third network device; an identifier of the at least one terminal; or an access type corresponding to each network slice in the allowed NSSAI, wherein the access type comprises 3GPP access and non-3GPP access.

Optionally, the total number and/or the proportion of the terminals registered to the network slice corresponding to the first S-NSSAI is determined by the first network device according to at least one of the following in the first information: an identifier of the second network device; an allowed NSSAI of at least one terminal stored in the third network device; an identifier of the at least one terminal; or an access type corresponding to each network slice in the allowed NSSAI.

Optionally, the first information also includes first instruction information.

The first instruction information is used to instruct the first network device to increase or decrease a number of terminals registered to the network slice.

Optionally, in a case where the third network device stores an allowed NSSAI of a terminal, the first instruction information is used to instruct the first network device to increase the number of terminals.

In a case where the third network device deletes an allowed NSSAI of a terminal, the first instruction information is used to instruct the first network device to decrease the number of terminals.

Optionally, the first network device is a primary network slice admission control function (NSACF), the second network device is an NSACF, and the third network device is an access and mobility management function AMF.

The communication device based on network slicing according to embodiments of the disclosure can send the first information to the first network device, and the first information is used for the first network device to verify whether the total number and/or the proportion of terminals registered to the network slice corresponding to the first S-NSSAI reaches the quota corresponding to the first S-NSSAI after receiving the first request sent by the second network device; the first request is used to request the first network device to process the NSAC request related to the number of terminals corresponding to the first S-NSSAI, and the third network device is controlled by the second network device, so that the core network can determine and verify the number of terminals belonging to a specific network slice, thereby preventing malicious fake requests, effectively maintaining the security of the communication system, and ensuring the communication quality of the system.

With reference to FIG. 14, FIG. 14 is a structural diagram of a communication device based on network slicing provided in embodiments of the present disclosure.

As shown in FIG. 14, the communication device 1400 based on network slicing includes: a transceiver unit 1410 and a processing unit 1420.

The transceiver unit 1410 is configured to receive a second request sent from a second network device, wherein the second request is used to request the first network device to process a network slice admission control (NSAC) request related to a number of protocol data unit (PDU) sessions corresponding to first single network slice selection assistance information (S-NSSAI).

The processing unit 1420 is configured to verify whether a total number of PDU sessions belonging to the network slice corresponding to the first S-NSSAI reaches a quota.

Optionally, the processing unit 1420 is further configured to: determine the total number of PDU sessions belonging to the network slice corresponding to the first S-NSSAI.

Optionally, the processing unit 1420 is configured to: determine, according to second information sent from a fourth network device to the first network device, the total number of PDU sessions belonging to the network slice corresponding to the first S-NSSAI, wherein the fourth network device is controlled by the second network device

Optionally, the second information includes at least one of: an identifier of the fourth network device; an identifier of the second network device; an identifier of at least one terminal; an identifier of at least one PDU session established for the at least one terminal; an S-NSSAI corresponding to each PDU session; or an access type corresponding to a network slice that corresponds to each S-NSSAI, wherein the access type comprises 3GPP access and non-3GPP access.

Optionally, the total number of PDU sessions belonging to the network slice corresponding to the first S-NSSAI is determined according to at least one of the following in the second information: an identifier of the second network device; an identifier of at least one terminal; an identifier of at least one PDU session established for the at least one terminal; or an access type corresponding to a network slice that corresponds to each S-NSSAI.

Optionally, the second information also includes second instruction information.

The second instruction information is used to instruct the first network device to increase or decrease a number of PDU sessions belonging to the network slice.

Optionally, in a case where the fourth network device establishes a PDU session for a terminal, the second instruction information is used to instruct the first network device to increase the number of PDU sessions.

In a case where the fourth network device releases a PDU session for a terminal, the second instruction information is used to instruct the first network device to decrease the number of PDU sessions.

Optionally, the processing unit 1420 is further configured to: in response to the total number of PDU sessions reaching the quota, sending a second response to the second network device, wherein the second response indicates that the first network device allows updating the quota of the number of PDU sessions in the first S-NSSAI; in response to the total number of PDU sessions not reaching the quota, rejecting the second request.

Optionally, the processing unit 1420 is further configured to: in response to the total number of the PDU sessions reaching the quota, performing network slice admission control; in response to the total number of the PDU sessions not reaching the quota, rejecting the second request.

Optionally, the first network device is a primary network slice admission control function (NSACF), the second network device is an NSACF, and the fourth network device is a session management function (SMF).

The communication device based on network slicing of this embodiment can receive the second request sent by the second network device, where the second request is used to request the first network device to process the NSAC request related to the number of PDU sessions corresponding to the first S-NSSAI, and verify whether the total number of PDU sessions belonging to the network slice corresponding to the first S-NSSAI reaches the quota, so that the core network can determine and verify the number of established PDU sessions belonging to a specific network slice, thereby preventing malicious fake requests, effectively maintaining the security of the communication system, and ensuring the communication quality of the system.

With reference to FIG. 15, FIG. 15 is a structural diagram of a communication device based on network slicing provided in embodiments of the present disclosure.

As shown in FIG. 15, the communication device 1500 based on network slicing includes a transceiver unit 1510.

The transceiver unit 1510 is configured to send second information to a first network device; wherein the second information is used for the first network device to verify whether a total number of PDU sessions belonging to a network slice corresponding to first single network slice selection assistance information (S-NSSAI) reaches a quota of a number of PDU sessions corresponding to the first S-NSSAI after receiving a second request sent from a second network device; the second request is used to request the first network device to process a network slice admission control (NSAC) request related to the number of PDU sessions corresponding to the first S-NSSAI; and the fourth network device is controlled by the second network device.

Optionally, the second information is used by the first network device to determine the total number of PDU sessions belonging to the network slice corresponding to the first S-NSSAI.

Optionally, the second information includes at least one of: an identifier of the fourth network device; an identifier of the second network device; an identifier of at least one terminal; an identifier of at least one PDU session established for the at least one terminal; an S-NSSAI corresponding to each PDU session; an access type corresponding to a network slice that corresponds to each S-NSSAI, wherein the access type comprises 3GPP access and non-3GPP access.

Optionally, the total number of PDU sessions belonging to the network slice corresponding to the first S-NSSAI is determined by the first network device according to at least one of the following in the second information: an identifier of the second network device; an identifier of at least one terminal; an identifier of at least one PDU session established for the at least one terminal; an access type corresponding to a network slice that corresponds to each S-NSSAI.

Optionally, the second information also includes second instruction information.

The second instruction information is used to instruct the first network device to increase or decrease a number of PDU sessions belonging to the network slice.

Optionally, in a case where the fourth network device establishes a PDU session for a terminal, the second instruction information is used to instruct the first network device to increase the number of PDU sessions.

In a case where the fourth network device releases a PDU session for a terminal, the second instruction information is used to instruct the first network device to decrease the number of PDU sessions.

Optionally, the first network device is a primary network slice admission control function (NSACF), the second network device is an NSACF, and the fourth network device is a session management function (SMF).

The communication device based on network slicing of this embodiment can send the second information to the first network device; the second information is used for the first network device to verify whether the total number of PDU sessions belonging to the network slice corresponding to the first S-NSSAI reaches the quota corresponding to the first S-NSSAI after receiving the second request sent by the second network device. The second request is used to request the first network device to process the NSAC request quota related to the number of PDU sessions corresponding to the first S-NSSAI. The fourth network device is controlled by the second network device, so that the core network can determine and verify the number of established PDU sessions belonging to a specific network slice, thereby preventing malicious fake requests, effectively maintaining the security of the communication system, and ensuring the communication quality of the system.

With reference to FIG. 16, FIG. 16 is a schematic diagram of a communication system provided in embodiments of the present disclosure.

As shown in FIG. 16, the communication system includes: a first network device, a second network device, and a third network device and/or a fourth network device.

As a possible implementation, the communication system includes: a first network device, a second network device and a third network device.

As another possible implementation, the communication system includes: a first network device, a second network device and a fourth network device.

As another possible implementation, the communication system includes: a first network device, a second network device, a third network device and a fourth network device.

The first network device can receive a request sent by the second network device, and determine and verify, based on the request, whether a number of registered terminals/established PDU sessions in a network slice reaches a quota according to information sent by the third network device and/or the fourth network device. When the quota is reached, the first network device sends a response to the second network device and updates the quota when necessary.

In order to implement the above-mentioned embodiments, embodiments of the present disclosure also propose a communication device, including: a processor and a memory having a computer program stored therein, and the processor executes the computer program stored in the memory so that the device executes the method shown in embodiments of FIGS. 2 to 4, or executes the method shown in embodiments of FIGS. 6 to 7.

In order to implement the above embodiments, embodiments of the present disclosure also propose a communication device, including: a processor and a memory having a computer program stored therein, and the processor executes the computer program stored in the memory so that the device executes the method shown in embodiments of FIG. 5.

In order to implement the above embodiments, embodiments of the present disclosure also propose a communication device, including: a processor and a memory having a computer program stored therein, and the processor executes the computer program stored in the memory so that the device executes the method shown in embodiments of FIG. 8.

In order to implement the above-mentioned embodiments, embodiments of the present disclosure also propose a communication device, including: a processor and an interface circuit, the interface circuit is used to receive code instructions and transmit them to the processor, and the processor is used to run the code instructions to execute the method shown in embodiments of FIGS. 2 to 4, or execute the method shown in embodiments of FIGS. 6 to 7.

In order to implement the above embodiments, the embodiments of the present disclosure also propose a communication device, including: a processor and an interface circuit, the interface circuit is used to receive code instructions and transmit them to the processor, and the processor is used to run the code instructions to execute the method shown in embodiments of FIG. 5.

In order to implement the above embodiments, the embodiments of the present disclosure also propose a communication device, including: a processor and an interface circuit, the interface circuit is used to receive code instructions and transmit them to the processor, and the processor is used to run the code instructions to execute the method shown in embodiments of FIG. 8.

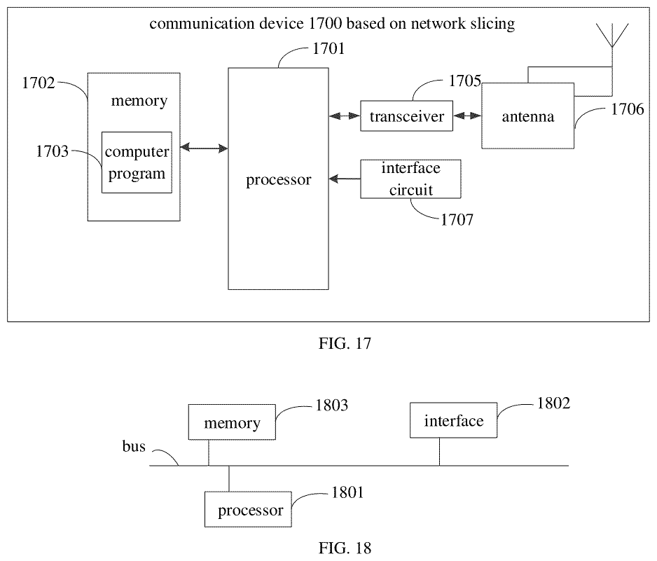

With reference to FIG. 17, which is a schematic diagram of the structure of another communication device based on network slicing provided in embodiments of the present disclosure. The communication device 1700 based on network slicing can be a network device, a resource owner client or a device running the resource owner client, a chip, a chip system, or a processor that supports the network device to implement the above method, or a chip, a chip system, or a processor that supports the resource owner client to implement the above method. The device can be used to implement the method described in the above method embodiment, and the details can be referred to the description in the above method embodiment.

The communication device 1700 based on network slicing may include one or more processors 1701. The processor 1701 may be a general-purpose processor or a dedicated processor, etc. For example, it may be a baseband processor or a central processing unit. The baseband processor may be used to process the communication protocol and communication data, and the central processing unit may be used to control the communication device based on network slicing (such as a base station, a baseband chip, a terminal, a terminal chip, a DU or a CU, etc.), execute a computer program, and process the data of the computer program.

Optionally, the network slicing-based communication device 1700 may further include one or more memories 1702, on which a computer program 1703 may be stored, and the processor 1701 executes the computer program 1703, so that the network slicing-based communication device 1700 performs the method described in the above method embodiment. The computer program 1703 may be solidified in the processor 1701, in which case the processor 1701 may be implemented by hardware.

Optionally, data may also be stored in the memory 1702. The network slicing-based communication device 1700 and the memory 1702 may be provided separately or integrated together.

Optionally, the network slicing-based communication device 1700 may further include a transceiver 1705 and an antenna 1706. The transceiver 1705 may be referred to as a transceiver unit, a transceiver, or a transceiver circuit, etc., for implementing a transceiver function. The transceiver 1705 may include a receiver and a transmitter, the receiver may be referred to as a receiver or a receiving circuit, etc., for implementing a receiving function; the transmitter may be referred to as a transmitter or a transmitting circuit, etc., for implementing a transmitting function.

Optionally, the network slicing-based communication device 1700 may further include one or more interface circuits 1707. The interface circuit 1707 is used to receive code instructions and transmit them to the processor 1701. The processor 1701 runs the code instructions to enable the network slicing-based communication device 1700 to perform the method described in the above method embodiment.

In one implementation, the processor 1701 may include a transceiver for implementing the receiving and sending functions. For example, the transceiver may be a transceiver circuit, an interface, or an interface circuit. The transceiver circuit, interface, or interface circuit for implementing the receiving and sending functions may be separate or integrated. The above-mentioned transceiver circuit, interface, or interface circuit may be used for reading and writing code/data, or the above-mentioned transceiver circuit, interface, or interface circuit may be used for transmitting or delivering signals.

In one implementation, the network slicing-based communication device 1700 may include a circuit that can implement the functions of sending, receiving, or communicating in the aforementioned method embodiments. The processor and transceiver described in the present disclosure can be implemented in an integrated circuit (IC), an analog IC, a radio frequency integrated circuit RFIC, a mixed signal IC, an application specific integrated circuit (ASIC), a printed circuit board (PCB), an electronic device, and the like. The processor and transceiver can also be manufactured using various IC process technologies, such as complementary metal oxide semiconductor (CMOS), N-type metal oxide semiconductor (nMetal-oxide-semiconductor, NMOS), P-type metal oxide semiconductor (positive channel metal oxide semiconductor, PMOS), bipolar junction transistor (bipolar junction transistor, BJT), bipolar CMOS (BiCMOS), silicon germanium (SiGe), gallium arsenide (GaAs), and the like.

The network slice-based communication device described in the above embodiment may be a network device or a resource owner client or a device running the resource owner client, but the scope of the network slice-based communication device described in the present disclosure is not limited thereto, and the structure of the network slice-based communication device may not be limited by FIGS. 12-14. The network slice-based communication device may be an independent device or may be part of a larger device. For example, the network slice-based communication device may be:
(1) Independent integrated circuit IC, or chip, or chip system or subsystem;
(2) having a set of one or more ICs, and optionally, the IC set may also include a storage component for storing data and computer programs;
(3) ASIC, such as modem;
(4) Modules that can be embedded in other devices;
(5) Receivers, terminals, intelligent terminals, cellular phones, wireless devices, handheld devices, mobile units, vehicle-mounted devices, network devices, cloud devices, artificial intelligence devices, etc.;
(6) Others.

For the case where the communication device based on network slicing can be a chip or a chip system, please refer to the structural diagram of the chip shown in FIG. 18. The chip shown in FIG. 18 includes a processor 1801 and an interface 1802. The number of processors 1801 can be one or more, and the number of interfaces 1802 can be multiple.

For the case where the chip is used to implement the functions of the network device in embodiments of the present disclosure:

Interface 1802, used for code instructions and transmission to the processor;

The processor 1801 is used to run code instructions to execute the method shown in FIGS. 2 to 4, or to execute the method shown in FIG. 5, or to execute the method shown in FIGS. 7 to 8, or to execute the method shown in FIG. 8.

Optionally, the chip further includes a memory 1803, and the memory 1803 is used to store necessary computer programs and data.

Those skilled in the art may also understand that the various illustrative logical blocks and steps listed in embodiments of the present disclosure may be implemented by electronic hardware, computer software, or a combination of the two. Whether such functions are implemented by hardware or software depends on the specific application and the design requirements of the entire system. Those skilled in the art may use various methods to implement the functions for each specific application, but such implementation should not be understood as exceeding the scope of protection of the embodiments of the present disclosure.

An embodiment of the present disclosure also provides a communication system, which includes the network slicing-based communication device as a network device in the aforementioned embodiments of FIGS. 12 to 15, or the system includes the network slicing-based communication device as a network device in the aforementioned embodiment of FIG. 17.

The present disclosure also provides a readable storage medium having instructions stored thereon, which implement the functions of any of the above method embodiments when executed by a computer.

The present disclosure also provides a computer program product, which implements the functions of any of the above method embodiments when executed by a computer.

In the above embodiments, it can be implemented in whole or in part by software, hardware, firmware or any combination thereof. When implemented using software, it can be implemented in whole or in part in the form of a computer program product. The computer program product includes one or more computer programs. When the computer program is loaded and executed on a computer, the process or function according to the embodiment of the present disclosure is generated in whole or in part. The computer can be a general-purpose computer, a special-purpose computer, a computer network, or other programmable device. The computer program can be stored in a computer-readable storage medium, or transmitted from one computer-readable storage medium to another computer-readable storage medium. For example, the computer program can be transmitted from a website site, computer, server or data center by wired (e.g., coaxial cable, optical fiber, digital subscriber line (digital subscriber line, DSL)) or wireless (e.g., infrared, wireless, microwave, etc.) mode to another website site, computer, server or data center. The computer-readable storage medium can be any available medium that a computer can access or a data storage device such as a server or data center that contains one or more available media integrations. Available media may be magnetic media (eg, floppy disks, hard disks, tapes), optical media (eg, high-density digital video discs (DVD)), or semiconductor media (eg, solid state disks (SSD)).

A person skilled in the art may understand that the various numerical numbers such as first and second involved in the present disclosure are only used for the convenience of description and are not used to limit the scope of the embodiments of the present disclosure, and also indicate the order of precedence.

At least one in the present disclosure can also be described as one or more, and a plurality can be two, three, four or more, which is not limited in the present disclosure. In embodiments of the present disclosure, for a technical feature, the technical features in the technical feature are distinguished by “first”, “second”, “third”, “A”, “B”, “C” and “D”, etc., and there is no order of precedence or size between the technical features described by the “first”, “second”, “third”, “A”, “B”, “C” and “D”.

The corresponding relationships shown in each table in the present disclosure can be configured or predefined. The values of the information in each table are only examples and can be configured as other values, which are not limited by the present disclosure. When configuring the corresponding relationship between the information and each parameter, it is not necessarily required to configure all the corresponding relationships illustrated in each table. For example, in the table in the present disclosure, the corresponding relationships shown in some rows may not be configured. For another example, appropriate deformation adjustments can be made based on the above table, such as splitting, merging, etc. The names of the parameters shown in the titles of the above tables can also use other names that can be understood by the communication device, and the values or representations of the parameters can also be other values or representations that can be understood by the communication device. When implementing the above tables, other data structures can also be used, such as arrays, queues, containers, stacks, linear lists, pointers, linked lists, trees, graphs, structures, classes, heaps, hash tables or hash tables.

The predefined in the present disclosure may be understood as defined, predefined, stored, pre-stored, pre-negotiated, preconfigured, solidified, or pre-burned.

Those of ordinary skill in the art will appreciate that the units and algorithm steps of each example described in conjunction with the embodiments disclosed herein can be implemented in electronic hardware, or a combination of computer software and electronic hardware. Whether these functions are performed in hardware or software depends on the specific application and design constraints of the technical solution. Professional and technical personnel can use different methods to implement the described functions for each specific application, but such implementation should not be considered to be beyond the scope of this application.

Those skilled in the art can clearly understand that, for the convenience and brevity of description, the specific working processes of the systems, devices and units described above can refer to the corresponding processes in the aforementioned method embodiments and will not be repeated here.

It should be understood that the various forms of processes shown above can be used to reorder, add or delete steps. For example, the steps recorded in embodiments of the present disclosure can be executed in parallel, sequentially or in different orders, as long as the desired results of the technical solution disclosed in the present invention can be achieved, and this document is not limited here.

The above specific implementations do not constitute a limitation on the protection scope of the present invention. It should be understood by those skilled in the art that various modifications, combinations, sub-combinations and substitutions can be made according to design requirements and other factors. Any modification, equivalent substitution and improvement made within the spirit and principle of the present invention should be included in the protection scope of the present invention.

1. A communication method based on network slicing, performed by a first network device, comprising:
receiving a first request sent from a second network device, wherein the first request is used to request the first network device to process a network slice admission control (NSAC) request related to a number of terminals corresponding to first single network slice selection assistance information (S-NSSAI); and
determining at least one of:
whether a total number of terminals registered to a network slice corresponding to the first S-NSSAI reaches a first quota; or
whether a proportion of terminals registered to the network slice corresponding to the first S-NSSAI reaches a second quota.

2. (canceled)

3. The method according to claim 1, further comprising:
determining, according to first information sent from a third network device to the first network device, the total number of the terminals registered to the network slice corresponding to the first S-NSSAI, wherein the third network device is controlled by the second network device; or
determining, according to first information sent from a third network device to the first network device, the proportion of the terminals registered to the network slice corresponding to the first S-NSSAI, wherein the third network device is controlled by the second network device.

4. The method according to claim 3, wherein the first information comprises at least one of:
an identifier of the third network device;
an identifier of the second network device;
an allowed NSSAI of at least one terminal stored in the third network device;
an identifier of the at least one terminal; or an access type corresponding to each network slice in the allowed NSSAI, wherein the access type comprises 3GPP (Third Generation Partnership Project) access and non-3GPP access.

5. (canceled)

6. The method according to claim 4, wherein the first information further comprises first instruction information;
the first instruction information is used to instruct the first network device to increase or decrease a number of terminals registered to the network slice.

7. The method according to claim 6, wherein
in a case where the third network device stores an allowed NSSAI of a terminal, the first instruction information is used to instruct the first network device to increase the number of terminals;
in a case where the third network device deletes an allowed NSSAI of a terminal, the first instruction information is used to instruct the first network device to decrease the number of terminals.

8. The method according to claim 1, further comprising:
in response to at least one of: the total number of terminals registered to the network slice corresponding to the first S-NSSAI reaching the first quota, or the proportion of terminals registered to the network slice corresponding to the first S-NSSAI reaching the second quota, sending a first response to the second network device, wherein the first response indicates that the first network device allows updating the quota of the terminals corresponding to the first S-NSSAI; in response to at least one of: the total number of terminals registered to the network slice corresponding to the first S-NSSAI not reaching the first quota, or the proportion of terminals registered to the network slice corresponding to the first S-NSSAI not reaching the second quota, rejecting the first request;
or
in response to at least one of: the total number of terminals registered to the network slice corresponding to the first S-NSSAI reaching the first quota, or the proportion of terminals registered to the network slice corresponding to the first S-NSSAI reaching the second quota, performing network slice admission control; in response to at least one of: the total number of terminals registered to the network slice corresponding to the first S-NSSAI not reaching the first quota, or the proportion of terminals registered to the network slice corresponding to the first S-NSSAI not reaching the second quota, rejecting the first request.

9. (canceled)

10. The method according to claim 1, wherein the first network device is a primary network slice admission control function (NSACF), the second network device is an NSACF, and the third network device is an access and mobility management function (AMF).

11. A communication method based on network slicing, performed by a third network device, comprising:
sending first information to a first network device; wherein the first information is used for the first network device to determine at least one of whether a total number of terminals registered to a network slice corresponding to first single network slice selection assistance information (S-NSSAI) reaches a first quota corresponding to the first S-NSSAI or whether a proportion of terminals registered to a network slice corresponding to first S-NSSAI reaches a second quota corresponding to the first S-NSSAI after receiving a first request sent from a second network device; the first request is used to request the first network device to process a network slice admission control (NSAC) request related to a number of terminals corresponding to the first S-NSSAI, and the third network device is controlled by the second network device.

12. The method according to claim 11, wherein the first information is used by the first network device to determine at least one of:
the total number of terminals registered to the network slice corresponding to the first S-NSSAI; or
the proportion of terminals registered to the network slice corresponding to the first S-NSSAI.

13. The method according to claim 11, wherein the first information comprises at least one of:
an identifier of the third network device;
an identifier of the second network device;
an allowed NSSAI of at least one terminal stored in the third network device;
an identifier of the at least one terminal; or
an access type corresponding to each network slice in the allowed NSSAI, wherein the access type comprises 3GPP access and non-3GPP access.

14. (canceled)

15. The method according to claim 11, wherein the first information further comprises first instruction information;
the first instruction information is used to instruct the first network device to increase or decrease a number of terminals registered to the network slice.

16. The method according to claim 15, wherein
in a case where the third network device stores an allowed NSSAI of a terminal, the first instruction information is used to instruct the first network device to increase the number of terminals; and
in a case where the third network device deletes an allowed NSSAI of a terminal, the first instruction information is used to instruct the first network device to decrease the number of terminals.

17. The method according to claim 11, wherein the first network device is a primary network slice admission control function (NSACF), the second network device is an NSACF, and the third network device is an access and mobility management function AMF.

18. A communication method based on network slicing, performed by a first network device, comprising:
receiving a second request sent from a second network device, wherein the second request is used to request the first network device to process a network slice admission control (NSAC) request related to a number of protocol data unit (PDU) sessions corresponding to first single network slice selection assistance information (S-NSSAI); and
determining whether a total number of PDU sessions belonging to a network slice corresponding to the first S-NSSAI reaches a quota.

19. (canceled)

20. The method according to claim 18, further comprising:
determining, according to second information sent from a fourth network device to the first network device, the total number of PDU sessions belonging to the network slice corresponding to the first S-NSSAI, wherein the fourth network device is controlled by the second network device.

21. The method according to claim 20, wherein the second information comprises at least one of:
an identifier of the fourth network device;
an identifier of the second network device;
an identifier of at least one terminal;
an identifier of at least one PDU session established for the at least one terminal;
an S-NSSAI corresponding to each PDU session; or
an access type corresponding to a network slice that corresponds to each S-NSSAI, wherein the access type comprises 3GPP access and non-3GPP access.

22. (canceled)

23. The method according to claim 20, wherein the second information further comprises second instruction information;
the second instruction information is used to instruct the first network device to increase or decrease a number of PDU sessions belonging to the network slice.

24. The method according to claim 23, wherein
in a case where the fourth network device establishes a PDU session for a terminal, the second instruction information is used to instruct the first network device to increase the number of PDU sessions;
in a case where the fourth network device releases a PDU session for a terminal, the second instruction information is used to instruct the first network device to decrease the number of PDU sessions.

25. The method according to claim 18, further comprising:
in response to the total number of PDU sessions reaching the quota, sending a second response to the second network device, wherein the second response indicates that the first network device allows updating the quota of the number of PDU sessions in the first S-NSSAI;
in response to the total number of PDU sessions not reaching the quota, rejecting the second request;
or
in response to the total number of the PDU sessions reaching the quota, performing network slice admission control; in response to the total number of the PDU sessions not reaching the quota, rejecting the second request.

26-38. (canceled)

39. A communication device, comprising a processor and a memory, wherein the memory stores a computer program, and the processor executes the computer program stored in the memory, to perform the method according to claim 1.

40.-42. (canceled)
